(19) United States
(12) Patent Application Publication
(10) Pub. No.: US 2026/0118673 A1
(43) Pub. Date: Apr. 30, 2026

(54) LIGHT GUIDE DEVICE AND ELECTRONIC DEVICE INCLUDING THE SAME

(71) Applicant: LG INNOTEK CO., LTD., Seoul (KR)

(72) Inventor: Bum Jin KIM, Seoul (KR)

(73) Assignee: LG INNOTEK CO., LTD., Seoul (KR)

(21) Appl. No.: 18/968,089

(22) Filed: Dec. 4, 2024

(30) Foreign Application Priority Data
Nov. 13, 2023 (KR) 10-2023-0156138
Sep. 24, 2024 (KR) 10-2024-0128798

(51) Int. Cl. G02B 27/01; G02B 27/09; G02B 27/42

(52) U.S. Cl. CPC G02B 27/0172; G02B 27/0944; G02B 27/4266; G02B 2027/0174

(57) ABSTRACT

Embodiments disclose a light guide device including a projector including a lens disposed to emit light and a barrel coupled to the lens, a first substrate that guides the light emitted from the projector, a first diffraction element region that is disposed on the first substrate and receives the light, and a second diffraction element region disposed on the first substrate and spaced apart from the first diffraction element region, wherein the lens includes a first lens disposed closest to the first substrate, the first diffraction element region overlaps the first lens of the projector in an optical axis direction of the first lens, and a diameter of the first diffraction element region of the first substrate is smaller than a diameter of the first lens of the projector.

### CROSS REFERENCE TO RELATED APPLICATION

The present application claims priority to Korean Patent Application No. 10-2024-0128798, filed Sep. 24, 2024 and 10-2023-0156138, filed Nov. 13, 2023 the entire contents of which is incorporated herein for all purposes by this reference.

### BACKGROUND OF THE INVENTION

### Field of the Invention

Embodiments relate to a light guide device and an electronic device including the same.

### Description of the Related Art

Virtual reality (VR) refers to a specific environment or situation that is similar to reality but not real, or a technology itself, created by an artificial technology using a computer, etc.

Augmented reality (AR) refers to a technology of synthesizing virtual objects or information into a real environment to make them appear as objects present in an original environment.

Mixed reality (MR) or hybrid reality refers to creating a new environment or new information in combination of the virtual world and the real world. In particular, the MR refers to real-time interaction between reality and virtual things.

In this case, the created virtual environment, situation, or the like stimulates a user's five senses and allows the user to do spatial and temporal experiences similar to reality so that the user freely moves between reality and imagination. In addition, the user can be not only easily immersed in such an environment, but also can interact with things implemented in such an environment, such as manipulation, commanding, etc., using a real device.

Recently, research on equipment (a gear or a device) used in such a technology field has been actively conducted. However, there is a growing need for miniaturization and improved optical performance of such equipment.

### SUMMARY OF THE INVENTION

Embodiments are directed to providing a light guide device and an electronic device, in which in using a light guide device used for augmented reality (AR) or the like, and an electronic device including the same, a diameter of a lens and a distance between a projector and a first diffraction element are adjusted, thereby increasing diffraction efficiency and enabling miniaturization and compactness.

In addition, embodiments are directed to providing a light guide device and an electronic device, which have a reduced volume by adjusting a position of each element.

The objects of embodiments are not limited thereto and may also include objects or effects that may be identified from the configurations or embodiments to be described below.

A light guide device according to an embodiment includes a projector including a lens disposed to emit light and a barrel coupled to the lens, a first substrate that guides the light emitted from the projector, a first diffraction element region that is disposed on the first substrate and receives the light, and a second diffraction element region disposed on the first substrate and spaced apart from the first diffraction element region, wherein the lens includes a first lens disposed closest to the first substrate, the first diffraction element region overlaps the first lens of the projector in an optical axis direction of the first lens, and a diameter of the first diffraction element region of the first substrate is smaller than a diameter of the first lens of the projector.

The diameter of the first diffraction element region of the first substrate may be smaller than a diameter of the barrel of the projector.

The first lens of the projector may be disposed to face the first diffraction element region of the first substrate.

The projector may have an angle of view,
the diameter of the first diffraction element region of the first substrate and the diameter of the first lens of the projector may satisfy Expression 1 below:

$$1.9 ⋆ [ IC / 2 + y 1 ] <= \text{} diameter of first lens <= 2.1 * [ IC / 2 + y 1 ] \qquad [ Equation 1 ]$$

$$y 1 = distance between first diffraction element region and L 1 S 1 * tan ( H\_Fov )$$

(here, IC denotes the diameter of the first diffraction element region, L1S1 denotes a surface of the first lens, which is adjacent to the first substrate, H_Fov denotes half or 0.5 times an angle of view of the projector, and distance between first diffraction element region and L1S1 denotes the shortest distance from the center of the first lens to the center of the diameter of the first diffraction element region).

The first diffraction element region of the first substrate may be disposed on a surface of two surfaces of the first substrate, which does not face the first lens of the projector.

The projector may have an angle of view,
the diameter of the first diffraction element region of the first substrate and the diameter of the first lens of the projector may satisfy Expression 2 below:

$$1.9 * [ IC / 2 + y 2 ] <= diameter of first lens <= 2.1 * [ IC / 2 + y 2 ] \qquad [ Equation 2 ]$$

$$y 2 = distance between WG 1 S 2 and L 1 S 1 * tan ( H \_ Fov ) +$$

$$thickness of first substrate ( WG 1 ) * tan ( a sin ( n 0 * sin ( H \_ Fov ) / n \_ WG 1 ) )$$

(here, IC denotes the diameter of the first diffraction element region, L1S1 denotes a surface of the first lens, which is adjacent to the first substrate, WG1S2 denotes a surface of the first substrate, which is adjacent to the first lens of the projector, H_Fov denotes ½ time an angle of view θb of the projector, no denotes a diffractive index of air, and n_WG1 denotes a diffractive index of the first substrate).

The light guide device may include an optical member disposed on the first diffraction element region of the first substrate.

A diffractive index of the optical member may be greater than a diffractive index of air and may be equal to or smaller than a diffractive index of the first substrate.

A thickness of the optical member may be equal to or smaller than a thickness of the first substrate.

A size of the optical member may be larger than a diameter of the first lens of the projector.

A distance between the optical member and the first substrate may be shorter than a distance between the optical member and the first lens of the projector.

The projector may have an angle of view,
the diameter of the first diffraction element region of the first substrate and the diameter of the first lens of the projector may satisfy Expression 3 below:

$$1.9 * [ IC / 2 + y 3 ] <= diameter of first lens <= 2.1 * [ IC / 2 + y 3 ] \qquad [ Equation 3 ]$$

$$y 3 = ( distance between WG 1 S 2 and L 1 S 1 - thickness of optical member * tan ( H \_ Fov ) + thickness of optical member * tan ( a sin ( n 0 * sin ( H \_ Fov ) / n 1 ) )$$

(here, IC denotes the diameter of the first diffraction element region, L1S1 denotes a surface (a first lens surface) of the first lens, which is adjacent to the first substrate, WG1S2 denotes a surface (a second surface) of the first substrate, which is adjacent to the first lens of the projector, H_Fov denotes ½ of an angle of view θb of the projector, n0 denotes a refractive index of air, n_WG1 denotes a refractive index of the first substrate, and n1 denotes a refractive index of the optical member).

A length from the first substrate to the optical member may be smaller than the thickness of the optical member.

A light guide device according to an embodiment includes a projector including a lens disposed to emit light and a barrel coupled to the lens, a first substrate that guides the light emitted from the projector and disposed adjacent to the projector and a second substrate disposed under the first substrate, a first diffraction element region that is disposed on the first substrate and receives the light, and a second diffraction element region disposed on the first substrate and spaced apart from the first diffraction element region, wherein the lens includes a first lens disposed closest to the first substrate, the first diffraction element region overlaps the first lens of the projector in an optical axis direction of the first lens, and a diameter of the first diffraction element region of the first substrate is smaller than a diameter of the first lens of the projector.

The projector may have an angle of view,
the diameter of the first diffraction element region of the first substrate and the diameter of the first lens of the projector may satisfy Expression 1 below:

$$1.9 * [ IC / 2 + y 1 ] <= diameter of first lens <= 2.1 * [ IC / 2 + y 1 ] \qquad [ Equation 1 ]$$

$$y 1 = distance between first diffraction element region and L 1 S 1 * tan ( H \_ Fov )$$

(here, IC denotes the diameter of the first diffraction element region, L1S1 denotes a surface of the first lens, which is adjacent to the first substrate, H_Fov denotes half or 0.5 times an angle of view of the projector, and distance between first diffraction element region and L1S1 denotes the shortest distance from the center of the first lens to the center of the diameter of the first diffraction element region).

The projector may have an angle of view,
the first diffraction element region of the first substrate is disposed on a surface of two surfaces of the first substrate, which does not face the first lens of the projector, and
the diameter of the first diffraction element region of the first substrate and the diameter of the first lens of the projector may satisfy Expression 2 below:

$$1.9 * [ IC / 2 + y 2 ] <= diameter of first lens <= 2.1 * [ IC / 2 + y 2 ] \qquad [ Equation 2 ]$$

$$y 2 = d istance between WG 1 S 2 and L 1 S 1 * tan ( H \_ Fov ) +$$

$$thickness of first substrate ( WG 1 ) * tan ( a sin ( n 0 * sin ( H \_ Fov ) / n\_WG 1 ) )$$

(here, IC denotes the diameter of the first diffraction element region, L1S1 denotes a surface of the first lens, which is adjacent to the first substrate, WG1S2 denotes a surface of the first substrate, which is adjacent to the first lens of the projector, H_Fov denotes ½ time an angle of view θb of the projector, no denotes a diffractive index of air, and n_WG1 denotes a diffractive index of the first substrate).

The light guide device may include an optical member disposed on the first diffraction element region of the first substrate,

The projector may have an angle of view,
the diameter of the first diffraction element region of the first substrate and the diameter of the first lens of the projector may satisfy Expression 3 below:

$$1.9 * [ IC / 2 + y 3 ] <= diameter of first lens <= 2.1 * [ IC / 2 + y 3 ] \qquad [ Equation 3 ]$$

$$y 3 = ( distance between WG 1 S 2 and L 1 S 1 - thickness of optical member * tan ( H \_ Fov ) + thickness of optical member * tan ( a sin ( n 0 * sin ( H \_ Fov ) / n 1 ) )$$

(here, IC denotes the diameter of the first diffraction element region, L1S1 denotes a surface (a first lens surface) of the first lens, which is adjacent to the first substrate, WG1S2 denotes a surface (a second surface) of the first substrate, which is adjacent to the first lens of the projector, H_Fov denotes ½ of an angle of view θb of the projector, no denotes a refractive index of air, n_WG1 denotes a refractive index of the first substrate, and n1 denotes a refractive index of the optical member).

### BRIEF DESCRIPTION OF THE DRAWINGS

FIG. 1 is a block diagram illustrating a configuration of an extended reality electronic device according to an embodiment of the present invention.

FIG. 2 is a perspective view illustrating an augmented reality electronic device according to the embodiment of the present invention.

FIG. 3 is a perspective view illustrating a projection device according to an embodiment.

FIG. 4 is a cross-sectional view illustrating the projection device according to the embodiment.

FIG. 5 is a view illustrating a projection device and a light guide device according to a first embodiment.

FIG. 6 is an enlarged view of portion K1 in FIG. 5.

FIG. 7 is a view illustrating the light guide device according to the first embodiment.

FIG. 8 is an enlarged view of portion K2 in FIG. 7.

FIG. 9 is a view illustrating a projection device and a light guide device according to a second embodiment.

FIG. 10 is an enlarged view of portion K3 in FIG. 9.

FIG. 11 is a view illustrating a projection device and a light guide device according to a third embodiment.

FIG. 12 is an enlarged view of portion K4 in FIG. 11.

FIG. 13 is a view illustrating a projection device and a light guide device according to a fourth embodiment.

FIG. 14 is an enlarged view of portion K5 in FIG. 13.

FIG. 15 is a graph illustrating the effect of the light guide device according to the embodiment.

FIG. 16 is a view for describing a length when the light guide device according to the embodiment is used.

FIG. 17 is a view illustrating a projection device and a light guide device according to a fifth embodiment.

FIG. 18 is an enlarged view of portion K6 in FIG. 17.

FIG. 19 is a view illustrating a projection device and a light guide device according to a sixth embodiment.

FIG. 20 is a view illustrating a light guide device according to a seventh embodiment.

FIG. 21 is a block diagram illustrating an example (a camera module) of the electronic device according to the embodiment.

FIG. 22 is a view for describing a configuration and operation of the camera module of FIG. 21.

FIG. 23 is a modified example of FIG. 22.

### DETAILED DESCRIPTION OF THE INVENTION

Hereinafter, exemplary embodiments of the present invention will be described in detail with reference to the accompanying drawings.

However, the technical spirit of the present invention is not limited to some of the described embodiments, but may be implemented in various different forms, and one or more of the components among the embodiments may be used by being selectively coupled or substituted without departing from the scope of the technical spirit of the present invention.

In addition, terms (including technical and scientific terms) used in embodiments of the present invention may be construed as meaning that may be generally understood by those skilled in the art to which the present invention pertains unless explicitly specifically defined and described, and the meanings of the commonly used terms, such as terms defined in a dictionary, may be construed in consideration of contextual meanings of related technologies.

In addition, the terms used in the embodiments of the present invention are for describing the embodiments and are not intended to limit the present invention.

In the specification, a singular form may include a plural form unless otherwise specified in the phrase, and when described as “at least one (or one or more) of A, B, and C,” one or more among all possible combinations of A, B, and C may be included.

In addition, the terms, such as first, second, A, B, (a), and (b) may be used to describe components of the embodiments of the present invention.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by a third component present between the first component and the second component.

In addition, when a certain component is described as being formed or disposed on “on (above)” or “below (under)” another component, it may include not only a case in which two components are in direct contact with each other, but also a case in which one or more other components are formed or disposed between the two components. In addition, when described as “on (above) or below (under),” it may include the meaning of not only an upward direction but also a downward direction based on one component.

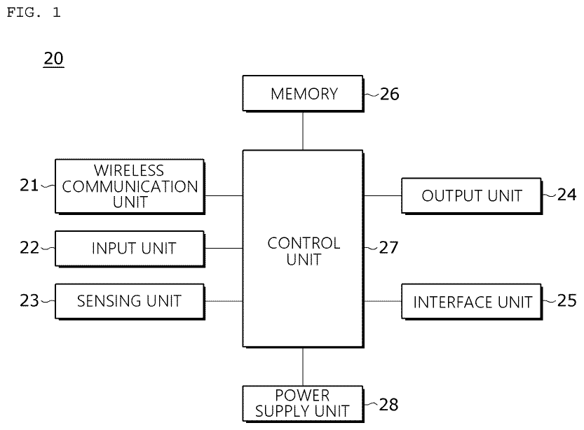

FIG. 1 is a block diagram illustrating a configuration of an extended reality electronic device according to an embodiment of the present invention.

Referring to FIG. 1, an extended reality electronic device 20 may include a wireless communication unit 21, an input unit 22, a sensing unit 23, an output unit 24, an interface unit 25, a memory 26, a control unit 27, and a power supply unit 28. Since the components illustrated in FIG. 1 are not essential in implementing the electronic device 20, the electronic device 20 described herein may have a larger or fewer number of components than the components listed above.

More specifically, among the components, the wireless communication unit 21 may include one or more modules that enable wireless communication between the electronic device 20 and a wireless communication system, between the electronic device 20 and another electronic device, or between the electronic device 20 and an external server. In addition, the wireless communication unit 21 may include one or more modules that connect the electronic device 20 to one or more networks.

The wireless communication unit 21 may include at least one of a broadcast reception module, a mobile communication module, a wireless Internet module, a short-range communication module, and a position information module.

The input unit 22 may include a camera or a video input unit for inputting a video signal, a microphone or an audio input unit for inputting an audio signal, and a user input unit (e.g., a touch key, a mechanical key, etc.) for receiving information from a user. Voice data or image data collected by the input unit 22 may be analyzed and processed by the user's control command.

The sensing unit 23 may include one or more sensors for sensing at least one of internal information of the electronic device 20, information on a surrounding environment surrounding the electronic device 20, and user information.

For example, the sensing unit 23 may include at least one of a proximity sensor, an illumination sensor, a touch sensor, an acceleration sensor, a magnetic sensor, a G-sensor, a gyroscope sensor, a motion sensor, an RGB sensor, an infrared sensor (IR sensor), a finger scan sensor, an ultrasonic sensor, an optical sensor (e.g., a capturing device), a microphone, a battery gauge, an environmental sensor (e.g., a barometer, a hygrometer, a thermometer, a radiation detection sensor, a heat detection sensor, a gas detection sensor, etc.), and a chemical sensor (e.g., an electronic nose, a healthcare sensor, a biometric sensor, etc.). Meanwhile, the electronic device 20 disclosed herein may use information sensed by at least two or more of these sensors in combination.

The output unit 24 is for generating an output related to visual, auditory or tactile sensations and may include at least one of a display unit, an audio output unit, a haptic module, and a light output unit. The display unit may be formed in a mutual layer structure with a touch sensor or formed as a single body to implement a touch screen. The touch screen may serve as a user input device for providing an input interface between the AR electronic device 20 and the user and provide an output interface between the AR electronic device 20 and the user.

The interface unit 25 serves as a passage for various types of external devices connected to the electronic device 20. Through the interface unit 25, the electronic device 20 may receive a VR or AR content from the external device and perform mutual interaction by exchanging various input signals, sensing signals, and data.

For example, the interface unit 25 may include a wired/wireless headset port, an external charger port, a wired/wireless data port, a memory card port, a port connecting a device in which an identification module is provided, an audio input/output (I/O) port, a video I/O port, and an earphone port.

In addition, the memory 26 stores data that supports various functions of the electronic device 20. The memory 26 may store a number of application programs that are run on the electronic device 20, data for the operation of the electronic device 20, and commands. At least some of these application programs may be downloaded from an external server via wireless communication. In addition, the at least some of these application programs may be present on the electronic device 20 from the time of shipment for basic functions (e.g., call reception and transmission functions and message reception and transmission functions) of the electronic device 20.

In addition to the operations related to the application program, the control unit 27 typically controls the overall operation of the electronic device 20. The control unit 27 may process signals, data, information, etc. input or output through the above-described components.

In addition, the control unit 27 may control at least some of the components by executing the application program stored in the memory 26 to provide appropriate information to the user or process functions. Furthermore, the control unit 27 may operate at least two or more of the components included in the electronic device 20 in combination to execute the application program.

In addition, the control unit 27 may detect the movement of the electronic device 20 or the user using the gyroscope sensor, the gravity sensor, the motion sensor, or the like included in the sensing unit 23. Alternatively, the control unit 27 may detect an object approaching the electronic device 20 or the user using the proximity sensor, the illumination sensor, the magnetic sensor, the IR sensor, the ultrasonic sensor, the optical sensor, or the like included in the sensing unit 23. In addition, the control unit 27 may detect the user's movement through sensors provided in the controller operated in conjunction with the electronic device 20.

In addition, the control unit 27 may perform the operation (or the function) of the electronic device 20 using the application program stored in the memory 26.

The power supply unit 28 receives external power or internal power under the control of the control unit 27 and supplies power to each component included in the electronic device 20. The power supply unit 28 includes a battery, and the battery may be provided in a built-in or replaceable form.

At least some of the components may cooperatively operate to implement the operation, control, or control method of the electronic device according to various embodiments described below. In addition, the operation, control, or control method of the electronic device may be implemented on the electronic device by executing at least one application program stored in the memory 26.

Hereinafter, an electronic device described as an example of the present invention will be described based on an embodiment applied to a head mounted display (HMD). However, the embodiment of the electronic device according to the present invention may include a mobile phone, a smart phone, a laptop computer, a digital broadcasting terminal, a personal digital assistant (PDA), a portable multimedia player (PMP), a navigation system, a slate PC, a tablet PC, an ultrabook, a wearable device, and the like. In addition to the HMD, the wearable device may include a watch-type terminal (smart watch), a contact lens, a VR/AR/MR glass, and the like.

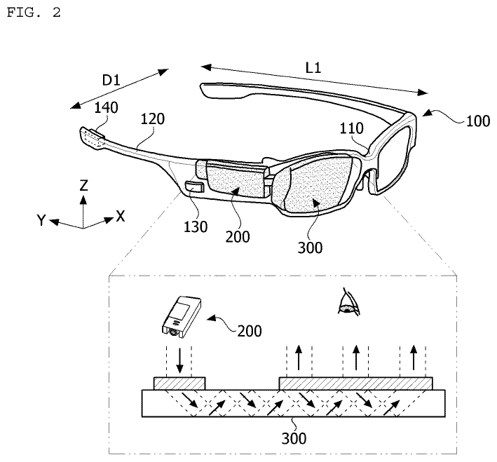

FIG. 2 is a perspective view illustrating an AR electronic device according to the embodiment of the present invention.

As illustrated in FIG. 2, the electronic device according to the embodiment of the present invention may include a frame 100, a projection device 200, and a display unit 300.

The electronic device may be formed of a glass type (smart glass). The glass type of the electronic device is configured to be worn on the head of the human body and to this end, may have a frame 100 (a case, a housing, etc.). The frame 100 may be formed of a flexible material for easy wearing.

The frame 100 is supported on the head and provides a space in which various components are mounted. As illustrated, electronic components such as the projection device 200, a user input unit 130, an audio output unit 140, etc. may be mounted on the frame 100. In addition, a lens covering at least one of left and right eyes may be detachably mounted on the frame 100.

As illustrated in the drawing, the frame 100 may have a form of glasses worn on the face of the user's body, but is not necessarily limited thereto, and may have a form such as a goggle worn in close contact with the user's face.

The frame 100 may include a front frame 110 having at least one opening, and a pair of side frames 120 extending in a y direction (in FIG. 2) intersecting the front frame 110 and being parallel to each other.

The frame 100 may have a length DI in an x direction and a length LI in the y direction that are the same or different.

The projection device 200 is provided to control various electronic components provided in the electronic device. The projection device 200 may be used interchangeably with “an optical output device,” “an optical projection device,” “light radiation device,” “optical device,” “projector,” or the like.

The projection device 200 may generate an image displayed to the user or a video having continuous images. The projection device 200 may include an image source panel for generating an image, a plurality of lenses for diffusing and converging light generated from the image source panel, and the like.

The projection device 200 may be fixed to one of two side frames 120. For example, the projection device 200 may be fixed to an inner side or outer side of one side frame 120 or formed integrally by being built into the one side frame 120. Alternatively, the projection device 200 may be fixed to the front frame 110 or provided separately from the electronic device.

The display unit 300 may be implemented in a HMD form. The HMD form refers to a display method mounted on the head to display an image directly in front of the user's eyes. When the user wears the electronic device, the display unit 300 may be disposed to correspond to at least one of the left eye and the right eye to provide the image directly in front of the user's eyes. This drawing illustrates an example in which the display unit 300 is positioned in front of a portion corresponding to the right eye to output the image toward the user's right eye. However, as described above, the present invention is not limited thereto, and the display unit 300 may be disposed in front of both the left and right eyes.

The display unit 300 may allow the user to visually recognize the external environment and at the same time, allow the user to see an image generated by the projection device 200. For example, the display unit 300 may project an image onto a display region using a prism.

In addition, the display unit 300 may be formed to be transparent so that the projected image and the general forward field of view (a range seen through the user's eyes) may be simultaneously seen. For example, the display unit 300 may be translucent and formed of an optical member including glass. For example, the display unit 300 may be a light guide device or may include the light guide device.

In addition, the display unit 300 may be fixedly inserted into an opening included in the front frame 110 or positioned on a rear surface of the opening (i.e., between the opening and the user) and fixed to the front frame 110. The drawing illustrates an example in which the display unit 300 is positioned on the rear surface of the opening and fixed to the front frame 110, but alternatively, the display unit 300 may be fixedly disposed at various positions of the frame 100.

As illustrated in FIG. 2, when the projection device 200 projects image light for an image to one side of the display unit 300, the electronic device may emit the image light to the other side through the display unit 300 so that the user sees the image generated by the projection device 200.

Accordingly, the user may see the external environment through the opening of the frame 100 and at the same time, see the image generated by the projection device 200 together. That is, the image output through the display unit 300 may be viewed by overlapping the general field of view. The electronic device may provide AR that allows a virtual image to overlap a real image or background using such display characteristics to be displayed as a single image.

Furthermore, in addition to such driving, the external environment and the image generated from the projection device 200 may be provided to the user with a time difference for a short time when the person may not recognize. For example, the external environment may be provided to the person in one section of one frame, and the image provided from the projection device 200 may be provided to the person in another section.

Alternatively, both overlapping and time difference may be provided.

In addition, the projection device according to the embodiment may have a structure described below or have a structure that further includes a waveguide or/and glass in the corresponding structure. In addition, the projection device may include a digital light processing (DLP) projector or projection device.

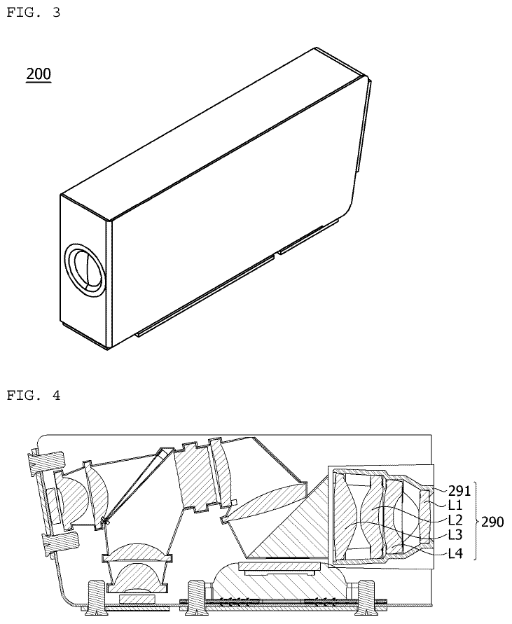

FIG. 3 is a perspective view of the projection device according to the embodiment, and FIG. 4 is a cross-sectional view of the projection device according to the embodiment.

Referring to FIGS. 3 and 4, the projection device 200 according to the embodiment may include a light source unit, a housing, a lens unit, a light modulator, and a projection lens unit 290.

The housing may have a space or housing groove in which each component of the projection device 200 is accommodated or disposed. The housing may be positioned at the outermost side of the projection device 200.

In addition, the housing may have a structure with one open side. Accordingly, the above-described components may be assembled through an open region or surface. The housing may have various shapes. For example, the housing may have a hexahedral structure. Accordingly, the projection device according to the embodiment may be easily mounted on the electronic device. In addition, the projection device according to the embodiment may be easily miniaturized or compactized.

The light source unit may be disposed inside the housing. The light source unit may be disposed adjacent to one of outer surfaces of the housing.

The light source unit may include at least one light source. In addition, when a plurality of light sources are present, the light sources may emit light of different wavelength bands or colors.

In addition, the lens unit may be formed of at least one optical element (e.g., a lens). The lens unit may condense light. With this configuration, it is possible to reduce the loss of light emitted from the light source and easily reduce the volume of the projection device.

In addition, the lens unit may align or change a path of the light by including a relay lens or the like. In addition, the lens unit may adjust the size of the lighting or image (maximum region of the light) provided by an illumination system or compensate for an optical difference.

In addition, the lens unit may include an element (e.g., a prism, etc.) for changing an optical path.

For example, the lens unit may include a total internal reflection prism (TIR prism). The prism may change the progress direction of light as described above. That is, the prism may perform transmission and reflection of the light. With this configuration, it is possible to miniaturize the projection device according to the embodiment.

The light modulator may be disposed at a rear end of the prism. The light modulator may emit the light transmitted by the prism back to the prism. The light modulator may reflect incident light and project a video. For example, the light modulator may emit or project a video or an image based on a video signal incident through a substrate and the like. That is, the light modulator may modulate the light emitted from the light source.

The light modulator according to the embodiment may include a digital micromirror device (DMD). The light modulator may include a plurality of small mirrors.

The projection lens unit 290 may be disposed at the rear end of the prism. In addition, the projection lens unit 290 may be positioned at a rear end of the projection device 200. When the light emitted from the light modulator is reflected by the prism, the light reflected by the prism may be incident on the projection lens unit 290. The above-described light may be projected from the projection lens unit 290. The projection lens unit 290 may project the light emitted from the projection device onto a screen or a waveguide (or a display unit).

In the embodiment, the projection lens unit 290 may adjust the size of the image so that the light is incident on an entrance pupil diameter (EPD) of the waveguide or the like.

To this end, the projection lens unit 290 according to the embodiment may include a barrel 291 and a plurality of lenses L1 to L4 (or optical systems) disposed in the barrel.

The projection device according to the embodiment may include an illumination system and a projecting system (or a projecting system, a projecting unit, a projection unit, a projection unit, etc.).

The illumination system may include a prism as a component and receive light (illuminating light) from a light source and emit light in a predetermined direction. The illuminating light may be transmitted or provided to the light modulator of the projecting system.

The illumination system may include the prism, the light modulator, and the projection lens unit 290. The projecting system may include the prism as a component. In the embodiment, the prism may be an element of the illumination system and the projecting system.

Furthermore, the projecting system may further include the above-described illumination system. That is, the projecting system may modulate illumination light generated in the illumination system through the light modulator and emit or radiate the illumination light in a predetermined direction through the prism and the projection lens unit 290.

The light modulator may reflect the illumination light as patterned light or the like, and the patterned light may pass through the projection lens unit 290 and may be output to the outside of the projection device.

In addition, the output unit and the waveguide or wavelength guide (waveguide) of the projection device or the input unit of the light guide device may be positioned correspondingly.

In an embodiment, as described above, the projection lens unit 290 may include the plurality of lenses L1 to L4. The plurality of lenses may include a first lens L1, a second lens L2, a third lens L3, and a fourth lens L4. The first lens L1 may be positioned at the outermost side of the projection device 200. In addition, the first lens L1 may be positioned closest to the light guide device, the waveguide of the light guide device, or a first substrate. Accordingly, light transmitting the first lens L1 may be guided to the first substrate of the light guide device.

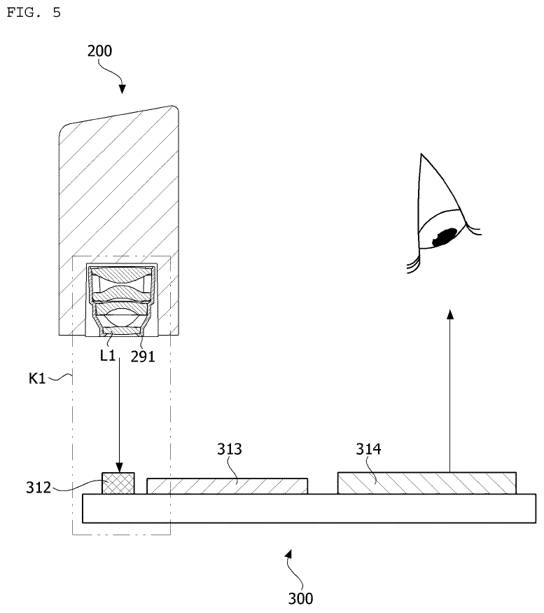

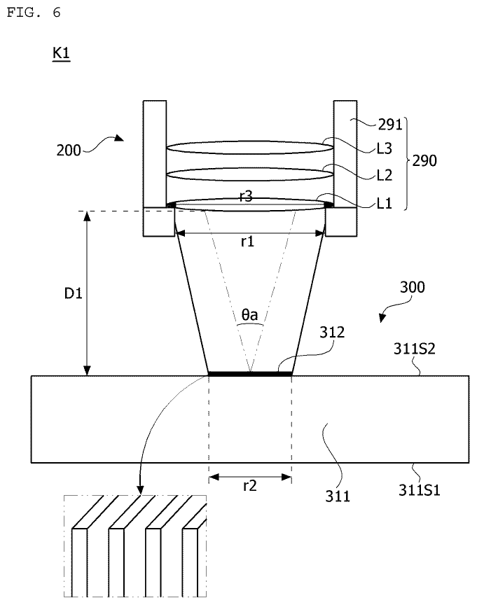

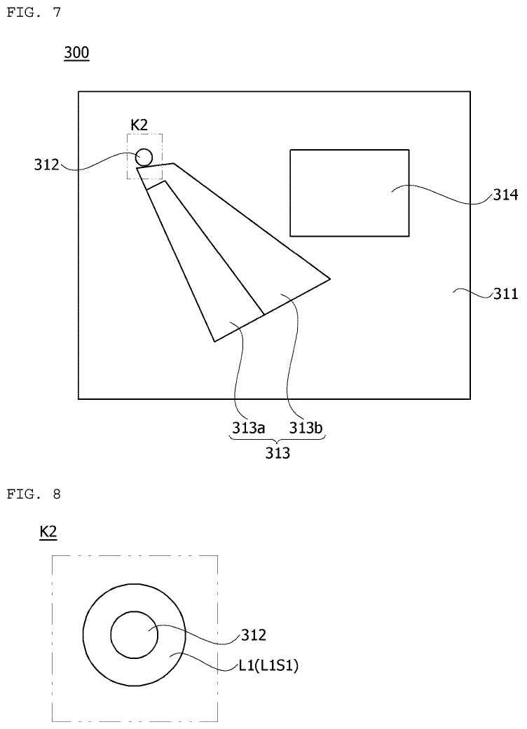

FIG. 5 is a view illustrating a projection device and a light guide device according to a first embodiment, FIG. 6 is an enlarged view of portion K1 in FIG. 5, FIG. 7 is a view illustrating the light guide device according to the first embodiment, and FIG. 8 is an enlarged view of portion K2 in FIG. 7.

Referring to FIGS. 5 to 8, in the present embodiment, the light guide device 300 may or may not include the projection device 200. For example, the light guide device 300 may include the projection device 200, a substrate, and a diffraction element (diffraction element region). Alternatively, the light guide device 300 may include a substrate and a diffraction element (diffraction element region).

The light guide device 300 according to the first embodiment may include a first substrate 311 and first diffraction element units 312, 313, and 314. Furthermore, the light guide device 300 according to the embodiment may include a projection device (hereinafter referred to as a projector) 200. As described above, the light guide device 300 may be a structure separated from the projector 200, and in this case, the first lens L1 of the projector 200 and the light guide device 300, which will be described below, may be disposed to be spaced apart from each other. In addition, the projector 200 may include the projection lens unit 290 including the plurality of lenses and the barrel 291 as described above. In particular, the lens of the projector 200 may include the first lens L1. In this case, the first lens L1 may be disposed closest to the first substrate 311.

In addition, a first diffraction element unit according to the embodiment may include a plurality of diffraction element regions. The first diffraction element unit may be disposed on the first substrate 311 and may have a nano-unit pattern. Accordingly, the first diffraction element unit may diffract and guide light incident from the projector 200. For example, the first diffraction element unit may include a first diffraction element region 312 and a second diffraction element region 314. Furthermore, the first diffraction element unit may include a third diffraction element region 313 positioned between the first diffraction element region 312 and the second diffraction element region 314. The first diffraction element region 312 may correspond to “an in-coupler.” The second diffraction element region 314 may correspond to “an out-coupler.” The third diffraction element region 313 may correspond to a folding grating.

The light guide device 300 may change the path of light output from the light output unit and output the light back to the outside. The light may be sequentially incident on the first diffraction element region 312, the third diffraction element region 313, and the second diffraction element 314 and output back to the outside. A direction of the light incident on the light guide device 300 may be a first direction. The first direction may be a direction of incidence of light or a direction opposite thereto.

In an embodiment, the first substrate 311 may guide the light emitted from the projector 200. The first substrate 311 may serve as a path for transmitting light. The first diffraction element region 312, the third diffraction element region 313, and the second diffraction element region 314 may be disposed on the first substrate 311. The light may be totally reflected from the inside of the first substrate 311 and may travel along the inside of the first substrate 311. The first substrate 311 may include a waveguide. The first diffraction element region 312, the third diffraction element region 313, and the second diffraction element region 314 may be disposed to be spaced apart from each other on the first substrate 311. The first substrate 311 may extend in a second direction perpendicular to the first direction in which light is incident. A refractive index of the first substrate 311 may range from 1.4 to 2.0.

The first diffraction element region 312 may guide light to be incident on the first substrate 311. That is, the first diffraction element region 312 may serve as a guide for light. Alternatively, the first diffraction element region 312 may receive light. The first diffraction element region 312 may serve to guide light guide to be incident on the first substrate 311. The first diffraction element region 312 may be disposed on the first substrate 311. Light may be incident on the light guide device 300 through the first diffraction element region 312 from the outside or the projector 200 and transmitted to the second diffraction element region 314 and the third diffraction element region 313 along the first substrate 311. The first diffraction element region 312 may change the path of the light by diffracting the light.

The third diffraction element region 313 may serve to change the path of the light. The third diffraction element region 313 may be disposed on the first substrate 311. The third diffraction element region 313 may change the path of the light incident through the first diffraction element region 312. The third diffraction element region 313 may change the path of the light to guide the light toward the second diffraction element region 314. The third diffraction element region 313 may change the path of light by diffracting the light.

The second diffraction element region 314 may guide the light to be emitted to the outside such as the user, etc. The second diffraction element region 314 may be disposed on the first substrate 311. The light may be emitted to the outside of the light guide device 300 through the second diffraction element region 314. The second diffraction element region 314 may receive the light whose path has been changed from a first transmission element 1300 and emit the light externally. The second diffraction element region 314 may change the path of the light and emit the light externally. The first emission diffraction element may change the path of the light by diffracting the light. The second diffraction element region 314 may be disposed to be spaced apart from the first diffraction element region 312. In addition, the second diffraction element region 314 may emit light.

The first diffraction element region 312, the third diffraction element region 313, and the second diffraction element region 314 may include a plurality of protrusions. The plurality of protrusions may have a constant width, cycle, and height and may be disposed on the first diffraction element region 312, the third diffraction element region 313, and the second diffraction element region 314. The plurality of protrusions may protrude in the first direction on the first diffraction element region 312, the third diffraction element region 313, and the second diffraction element region 314. The plurality of protrusions may be disposed to be spaced apart from each other in a vector direction of the pattern including the protrusions. Depending on the widths, cycles, and heights of the plurality of protrusions, the path of the light may be changed differently after passing through the first diffraction element region 312, the third diffraction element region 313, and the second diffraction element region 314. The width of the protrusion may be a width of the pattern including the protrusion in the vector direction. The cycle of the protrusion may be an interval of the patterns including a protrusion between one side surface of the protrusion and the same side surface of an adjacent protrusion. The height of the protrusion may be a height of a portion of the protrusion, which protrudes in the first direction. The protrusion may be disposed to have a predetermined pattern.

In an embodiment, the first diffraction element region 312, the third diffraction element region 313, and the second diffraction element region 314 may be formed of the same material or different materials. For example, the first diffraction element region 312, the third diffraction element region 313, and the second diffraction element region 314 may be formed of the same material. In addition, refractive indices of the first diffraction element region 312, the third diffraction element region 313, and the second diffraction element region 314 may range from 1.7 to 2.7.

Furthermore, an outline (a boundary region) of the first diffraction element region 312 does not overlap an outline (a boundary region) of the third diffraction element region 313. When these outlines overlap each other, since a part of the light incident on the second diffraction element region 314 from the third diffraction element region 313 is covered, a video may not be emitted from the second diffraction element region 314 due to the covered region. Since the outline (the boundary region) of the first diffraction element region 312 overlap the outline (the boundary region) of the third diffraction element region 313, efficiency is reduced, and thus the outline (the boundary region) of the first diffraction element region 312 does not preferably overlap the outline (the boundary region) of the third diffraction element region 313.

The third diffraction element region 313 according to the embodiment may include a first region 313a adjacent to the second diffraction element region 314 and a second region 1320 that is in contact with the first region 313a and spaced from the second diffraction element region 314.

The first region 313a and the second region 1320 may be a part of the third diffraction element region 313. The first region 313a and the second region 313b may be two separated regions when the third diffraction element region 313 is viewed in the first direction in which a light signal is incident. The first region 313a may be a region of the third diffraction element region 313, which is adjacent to the second diffraction element region 314. The first region 313a may be a region of the third diffraction element region 313, which is adjacent to the first diffraction element region 312. The second region 313b may be a region of the third diffraction element region 313, which is spaced apart from the second diffraction element region 314. The second region 313b may be a region of the third diffraction element region 313, which is spaced apart from the first diffraction element region 312. A separation distance between the first region 313a and the second diffraction element region 314 may be smaller than a separation distance between the second region 313b and the second diffraction element region 314. Shapes or areas of the first region 313a and the second region 313b may be different. The first region 313a and the second region 313b may each include a plurality of surfaces. Some surfaces of the first region 313a may be in contact with some surfaces of the second region 313b.

The first region 313a may include a first pattern, and the first pattern may include a first protrusion protruding in the first direction. The second region 313b may include a second pattern and include a second protrusion protruding in the first direction. The first protrusion and the second protrusion may be portions protruding from the first region 313a and the second region 313b in the first direction, respectively. The first direction may be a direction in which the light emitted from the projector is incident on the first diffraction element region 312. The first direction may be a direction in which light is incident or a direction opposite thereto. The first direction is a direction perpendicular to the first substrate 311.

The first protrusion and the second protrusion may be disposed repeatedly with a predetermined cycle, width, and height on the first region 313a and the second region 313b. A plurality of first protrusions may be disposed perpendicular to the first direction and spaced apart from each other in the vector direction of the first region 313a of the third diffraction element region 313. A plurality of second protrusions may be disposed perpendicular to the first direction and spaced apart from each other in the vector direction of the second region 313b of the third diffraction element region 313.

In addition, in the light guide device 300 according to the embodiment, the first diffraction element region 312 may overlap the first lens L1 of the projector 200 in the optical axis direction (e.g., corresponding to the first direction when disposed vertically) of the first lens L1. That is, the first lens L1 may overlap the first diffraction element region 312 may overlap with respect to an optical axis direction of the first lens L1. With this configuration, light emitted through the first lens L1 of the projector 200 may be provided to the first diffraction element region 312 without loss. Accordingly, it is possible to minimize the light loss of the light guide device according to the embodiment, thereby providing increased light efficiency.

In addition, the first substrate 311 and the first diffraction element unit may have the same or different refractive indices. The refractive index of the first substrate 311 may range from 1.4 to 2.0. For example, the first substrate 311 may include glass. In addition, the first diffraction element unit may be made of an insulating material. For example, the first diffraction element unit may include a polymer, TiO₂, HfO₂, Al₂O₃, SiO₂, or the like. In addition, the refractive index of the first diffraction element unit may range from 1.7 to 2.7. A refractive index of the optical member (e.g., the cover glass) described below may range from 1.4 to 1.6.

In an embodiment, a diameter r2 of the first diffraction element region 312 on the first substrate 311 may be smaller than a diameter r3 of the first lens L1 of the projector 200.

In addition, the diameter r2 of the first diffraction element region 312 of the first substrate 311 may be smaller than a diameter r1 of the barrel 291 of the projector 200.

Therefore, the light guide device according to the embodiment may be easily miniaturized.

In addition, according to the embodiment, the first lens L1 of the projector 200 and the first diffraction element region 312 on the first substrate 311 may be disposed to face each other. Accordingly, the light guide device according to the embodiment can minimize the loss of light.

Furthermore, the projector 200 according to the embodiment may have a predetermined angle of view θa. The angle of view θa may be referred to as a field of view (FOV) an angle of view, or the like.

The diameter r2 of the first diffraction element region 312 on the first substrate 311 according to the embodiment and the diameter r3 of the first lens L1 of the projector 200 may satisfy Expression 1 below.

$$1.9 * [ IC / 2 + y 1 ] <= diameter of first lens <= 2.1 * [ IC / 2 + y 1 ] \qquad [ Equation 1 ]$$

$$y 1 = distance between first diffraction element region and L 1 S 1 ( first lens surface ) * tan ( H \_ Fov )$$

Here, IC denotes the diameter of the first diffraction element region, L1S1 denotes a surface of the first lens, which is adjacent to the first substrate, H_Fov denotes half or 0.5 times the angle of view θa of the projector, and distance between IC and L1S1 (D1) denotes the shortest distance from the center of the first lens to the center of the diameter of the first diffraction element region.

Accordingly, since the projector and the light guide device have a predetermined size and are disposed on the side surface (e.g., a region adjacent to the ear) of the user when the electronic device is worn on the user's face, a collision between the projector and the user's face can be avoided.

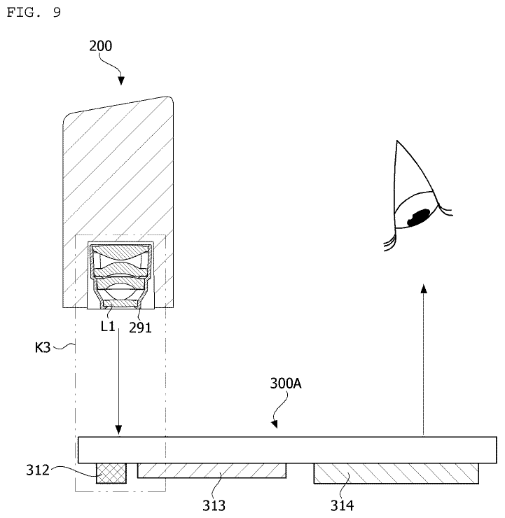

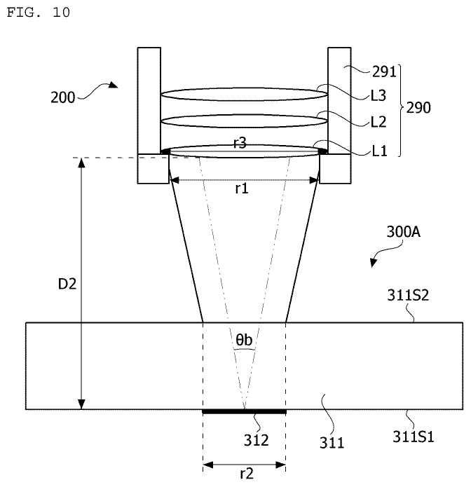

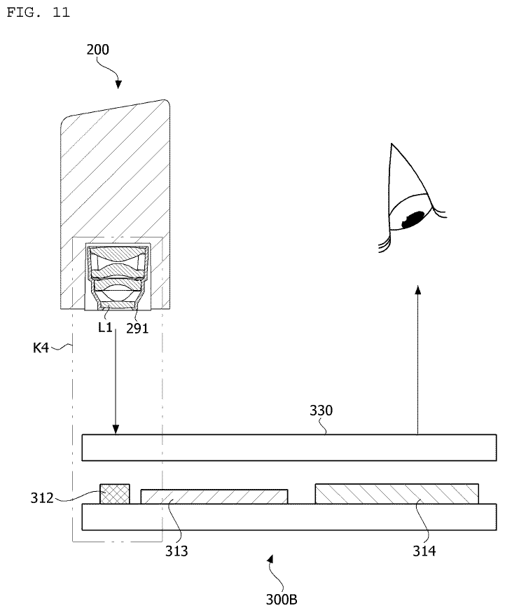

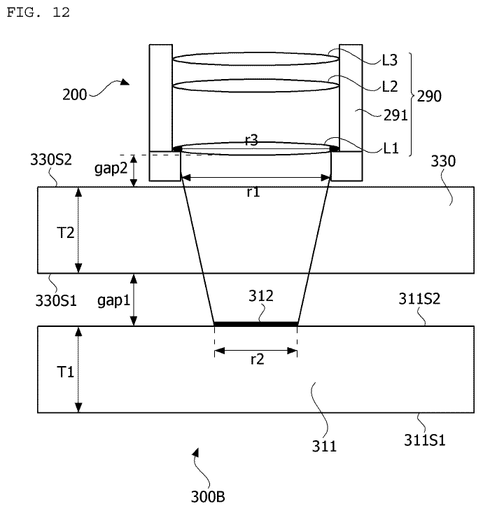

FIG. 9 is a view illustrating a projector and a light guide device according to a second embodiment, and FIG. 10 is an enlarged view of portion K3 in FIG. 9.

Referring to FIGS. 9 and 10, a light guide device 300A according to the second embodiment may include the first substrate 311 and the first diffraction element units 312, 313, and 314. Furthermore, the light guide device 300A may include the projector 200. Alternatively, the projector 200 may be separated from the light guide device 300A. All of the above-described contents excluding the following content may be applied to the description thereof.

In the present embodiment, the first diffraction element region 312 on the first substrate 311 may be disposed on a surface 311S1 or WG1S1 of two surfaces of the first substrate 311, which does not face the first lens L1 of the projector 200.

For example, the first substrate 311 may include two surfaces spaced apart from each other or facing each other in the first direction. The first substrate 311 may include a first surface 311S1 and a second surface 311S2. The first surface 311S1 may be the surface 311S1 that does not face the first lens L1. The second surface 3112 may be a surface facing the first lens L1. A distance between the first surface 311S1 and the first lens L1 may be greater than a distance between the second surface 311S2 and the first lens L1.

That is, unlike the first embodiment, in the present embodiment, the first diffraction element region 312 may be disposed on a surface (the first surface) of the first substrate 311, which is positioned further away from the projector 200 rather than a surface (the second surface) adjacent to the projector 200.

In addition, the first lens L1 may also include a second surface or a first lens surface L1S1 adjacent to the first substrate 311 and a second lens surface L1S2 facing the first lens surface L1S1. The second lens surface L1S2 may not face the first substrate 311.

According to an embodiment, the projector 200 may have the angle of view θb. In addition, in an embodiment, the diameter r2 of the first diffraction element region of the first substrate and the diameter r3 of the first lens of the projector may satisfy Expression 2 below.

$$1.9 * [ IC / 2 + y 2 ] <= diameter of first lens <= 2.1 * [ IC / 2 + y 2 ] \qquad [ Equation 2 ]$$

$$y 2 = distance ( D 2 ) between WG 1 S 2 and L 1 S 1 * tan ( H \_ Fov ) + thickness T1 ( see FIG . 12 ) of first substrate ( WG 1 ) * tan ( a sin ( n 0 * sin ( H \_ Fov ) / n\_WG 1 ) )$$

Here, IC denotes the diameter of the first diffraction element region, L1S1 denotes a surface (a first lens surface) of the first lens, which is adjacent to the first substrate, 311S2 or WG1S2 denotes a surface (a second surface) of the first substrate, which is adjacent to the first lens of the projector, and H_Fov denotes ½ of the angle of view θb of the projector. In addition, no denotes the refractive index of air, and n_WG1 denotes the refractive index of the first substrate.

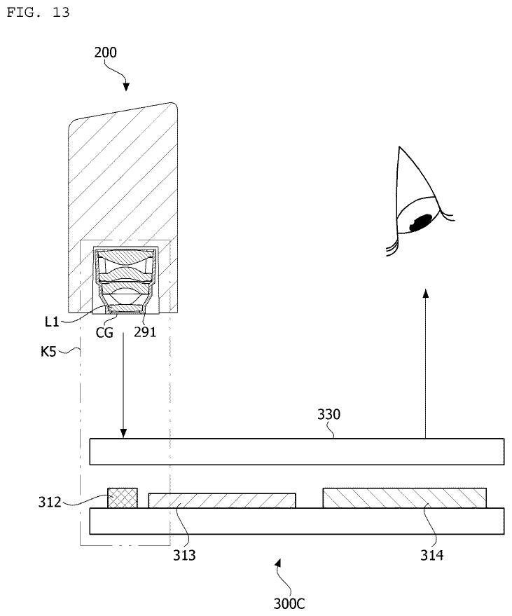

FIG. 11 is a view illustrating a projector and a light guide device according to a third embodiment, and FIG. 12 is an enlarged view of portion K4 in FIG. 11.

Referring to FIGS. 11 and 12, a light guide device 300B according to a third embodiment may include the first substrate 311 and the first diffraction element units 312, 313, and 314. Furthermore, the light guide device 300B may include the projector 200. Alternatively, the projector 200 may be separated from the light guide device 300B. All of the above-described contents excluding the following content may be applied to the description thereof.

In the present embodiment, the light guide device 300B may further include an optical member 330 in addition to the first substrate 311, the first diffraction element region 312, the third diffraction element region 313, and the second diffraction element region 314 as described above.

The optical member 330 may be positioned on the first substrate 311, the first diffraction element region 312, the third diffraction element region 313, and the second diffraction element region 314. The optical member 330 may be disposed adjacent to the projector 200 in comparison to the first substrate 311, the first diffraction element region 312, the third diffraction element region 313, and the second diffraction element region 314. The light may pass through the optical member 330 and may be incident on the first diffraction element region 312. In addition, the light may pass through the second diffraction element region and may be emitted through the optical member 330. The optical member 330 may have an effect of protecting the inside of the light guide device 300B. The optical member 330 may be “a cover glass.” A refractive index of the optical member 330 according to the embodiment may be greater than the refractive index of air and equal to or smaller than the refractive index of the first substrate 311. The refractive index of the optical member 330 may range from 1.4 to 1.6.

The size of the optical member 330 may be greater than the diameter of the first lens L1 of the projector 200. For example, the length of the optical member 330 in the second direction perpendicular to the first direction may be greater than the diameter r3 of the first lens L1.

In addition, a distance gap1 between the optical member 330 and the first substrate 311 may be smaller than a distance gap2 between the optical member 330 and the projector 200. With this configuration, it is possible to provide to minimize light deformation according to the shape of the user's face and miniaturize the light guide device.

In addition, in the present embodiment, the projector may have the angle of view θa.

In addition, the diameter r2 of the first diffraction element region 312 of the first substrate and the diameter r3 of the first lens L1 of the projector may satisfy Expression 3.

$$1.9 * [ IC / 2 + y 3 ] <= diameter r 3 of first lens <= 2.1 * [ IC / 2 + y 3 ] \qquad [ Equation 3 ]$$

$$y 3 = ( distance “ D 1 ” or “ gap1 + T 2 + gap2 ” between WG 1 S 2 ( or 311 S 2 ) and$$

$$L 1 S 1 - thickness T 2 of optical member * tan ( H \_ Fov ) +$$

$$thickness T 2 of optical member * tan ( a sin ( n 0 * sin ( H \_ Fov ) / n 1 ) )$$

Here, IC denotes the diameter of the first diffraction element region, L1S1 denotes the surface (the first lens surface) of the first lens, which is adjacent to the first substrate, 311S2 or WG1S2 denotes the surface (the second surface) of the first substrate, which is adjacent to the first lens of the projector, and H_Fov denotes ½ of the angle of view θb of the projector. In addition, no denotes the refractive index of air, and n_WG1 denotes the refractive index of the first substrate. In addition, n1 denotes the refractive index of the optical member 330.

In addition, in an embodiment, the length gap1 from the first substrate 311 to the optical member 330 may be smaller than the thickness T2 of the cover glass. Furthermore, the thickness T2 of the cover glass may be the same as or different from the thickness T1 of the first substrate 311.

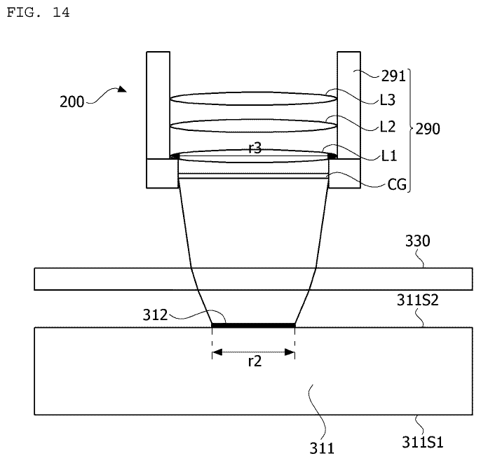

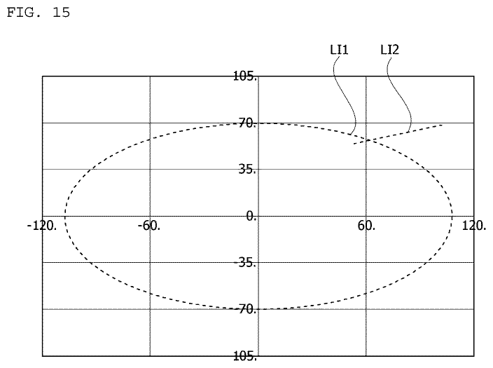

FIG. 13 is a view illustrating a projector and a light guide device according to a fourth embodiment, and FIG. 14 is an enlarged view of portion K5 in FIG. 13.

Referring to FIGS. 13 and 14, a light guide device 300C according to a fourth embodiment may include the first substrate 311 and the first diffraction element units 312, 313, and 314. Furthermore, the light guide device 300C may include the projector 200. Alternatively, the projector 200 may be separated from the light guide device 300C. All of the above-described contents excluding the following content may be applied to the description thereof.

In the present embodiment, the light guide device 300C may further include an optical member 330 in addition to the first substrate 311, the first diffraction element region 312, the third diffraction element region 313, and the second diffraction element region 314 as described above.

In addition, the projection lens unit of the projector 200 may further include an additional optical member CG. The additional optical member CG may be a cover glass.

In addition, in the present embodiment, the projector may have the angle of view θa.

In addition, the diameter r2 of the first diffraction element region 312 of the first substrate and the diameter r3 of the first lens L1 of the projector may satisfy Expression 4.

$$1.9 * [ Ic / 2 + y 3 ] <= diameter r 3 of first lens <= 2.1 * [ IC / 2 + y 3 ] \qquad [ Equation 4 ]$$

$$y 3 = ( distance “ D 1 ” or “ gap1 + T 2 + gap2 ” between WG 1 S 2 ( or 311 S 2 ) and L 1 S 1 - ( thickness of optical member + thickness of additional optical member ) * tan ( H \_ Fov ) + thickness of optical member 330 * tan ( a sin ( n 0 * sin ( H \_ Fov ) / n 1 ) ) + thickness of additional optical member CG * tan ( a sin ( n 0 * sin ( H \_ Fov ) / n 2 ) )$$

Here, L1S1 denotes the surface (the first lens surface) of the first lens adjacent to the first substrate, 311S2 or WG1S2 denotes the surface (the second surface) of the first substrate, which is adjacent to the first lens of the projector, and H_Fov denotes ½ of the angle of view θa of the projector. In addition, no denotes the refractive index of air, and n_WG1 denotes the refractive index of the first substrate. In addition, n1 denotes the refractive index of the optical member 330. n2 denotes the refractive index of the additional optical member CG.

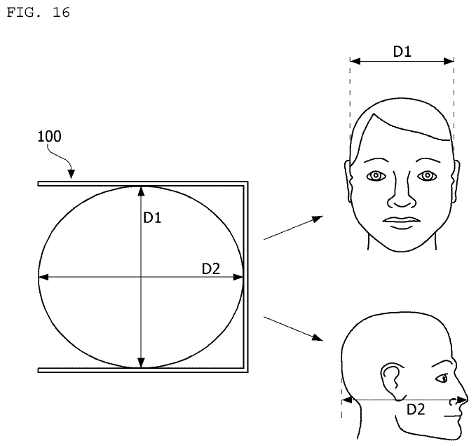

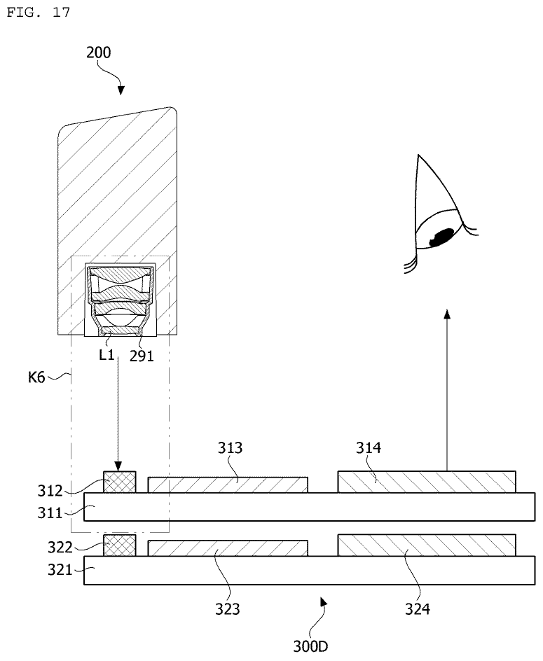

FIG. 15 is a graph illustrating the effect of the light guide device according to the embodiment, and FIG. 16 is a view for describing a length when the light guide device according to the embodiment is used.

Referring to FIGS. 15 and 16, the horizontal length D1 of the user's face (excluding the ears) and the vertical length D2 (the maximum distance from the tip of the nose to the back of the head) of the user's face each define a head ellipse based on the 50th percentile (e.g., a median). Accordingly, D1 is set as 139 mm, and D2 is set as 215 mm. Hereinafter, the units of a length, a thickness, and the like are mm.

TABLE 1

| | | | | | Difference | |
|---|---|---|---|---|---|---|
| | | | | | between | |
| | | | | | “0.5 | |
| | | | | | times | Difference |
| | | | | | horizontal | between |
| | | | | | length | “0.5 |
| | | | | | D1 of | times |
| | | | | | face” and | vertical |
| | | | | | “sum of | length D2 |
| | | | | | length of | of face” |
| Thickness | | | | Length of | projector | and “sum |
| of | | | | project + | and | of |
| optical | | | Distance | distance | distance | thickness |
| member | | | between | between | between | of barrel |
| (330) | | | projector | projector | projector | and |
| (cover | Minimum | Minimum | and first | and first | and first | minimum |
| glass) | r3*0.5 | r3 | substrate | substrate | substrate” | r3*0.5” |
| 0.112586163 | 1.612586163 | 3.225172326 | 0.65 | 2.15 | 105.35 | 66.88741384 |
| 0.166176002 | 1.666176002 | 3.332352003 | 0.85 | 2.35 | 105.15 | 66.833824 |
| 0.21976584 | 1.71976584 | 3.43953168 | 1.05 | 2.55 | 104.95 | 66.78023416 |
| 0.353740436 | 1.853740436 | 3.707480873 | 1.55 | 3.05 | 104.45 | 66.64625956 |
| 0.487715033 | 1.987715033 | 3.975430065 | 2.05 | 3.55 | 103.95 | 66.51228497 |
| 0.621689629 | 2.121689629 | 4.243379258 | 2.55 | 4.05 | 103.45 | 66.37831037 |
| 0.755664225 | 2.255664225 | 4.51132845 | 3.05 | 4.55 | 102.95 | 66.24433578 |
| 0.889638821 | 2.389638821 | 4.779277642 | 3.55 | 5.05 | 102.45 | 66.11036118 |
| 1.023613417 | 2.523613417 | 5.047226835 | 4.05 | 5.55 | 101.95 | 65.97638658 |
| 1.157588014 | 2.657588014 | 5.315176027 | 4.55 | 6.05 | 101.45 | 65.84241199 |
| 1.29156261 | 2.79156261 | 5.58312522 | 5.05 | 6.55 | 100.95 | 65.70843739 |
| 1.425537206 | 2.925537206 | 5.851074412 | 5.55 | 7.05 | 100.45 | 65.57446279 |
| 1.559511802 | 3.059511802 | 6.119023605 | 6.05 | 7.55 | 99.95 | 65.4404882 |
| 1.693486398 | 3.193486398 | 6.386972797 | 6.55 | 8.05 | 99.45 | 65.3065136 |
| 1.827460995 | 3.327460995 | 6.654921989 | 7.05 | 8.55 | 98.95 | 65.17253901 |
| 1.961435591 | 3.461435591 | 6.922871182 | 7.55 | 9.05 | 98.45 | 65.03856441 |
| 2.095410187 | 3.595410187 | 7.190820374 | 8.05 | 9.55 | 97.95 | 64.90458981 |
| 2.229384783 | 3.729384783 | 7.458769567 | 8.55 | 10.05 | 97.45 | 64.77061522 |
| 2.36335938 | 3.86335938 | 7.726718759 | 9.05 | 10.55 | 96.95 | 64.63664062 |
| 2.497333976 | 3.997333976 | 7.994667952 | 9.55 | 11.05 | 96.45 | 64.50266602 |
| 2.631308572 | 4.131308572 | 8.262617144 | 10.05 | 11.55 | 95.95 | 64.36869143 |
| 2.765283168 | 4.265283168 | 8.530566336 | 10.55 | 12.05 | 95.45 | 64.23471683 |
| 2.899257764 | 4.399257764 | 8.798515529 | 11.05 | 12.55 | 94.95 | 64.10074224 |
| 3.033232361 | 4.533232361 | 9.066464721 | 11.55 | 13.05 | 94.45 | 63.96676764 |
| 3.167206957 | 4.667206957 | 9.334413914 | 12.05 | 13.55 | 93.95 | 63.83279304 |
| 3.301181553 | 4.801181553 | 9.602363106 | 12.55 | 14.05 | 93.45 | 63.69881845 |
| 3.435156149 | 4.935156149 | 9.870312299 | 13.05 | 14.55 | 92.95 | 63.56484385 |
| 3.569130746 | 5.069130746 | 10.13826149 | 13.55 | 15.05 | 92.45 | 63.43086925 |
| 3.703105342 | 5.203105342 | 10.40621068 | 14.05 | 15.55 | 91.95 | 63.29689466 |
| 3.837079938 | 5.337079938 | 10.67415988 | 14.55 | 16.05 | 91.45 | 63.16292006 |
| 3.971054534 | 5.471054534 | 10.94210907 | 15.05 | 16.55 | 90.95 | 63.02894547 |
| 4.10502913 | 5.60502913 | 11.21005826 | 15.55 | 17.05 | 90.45 | 62.89497087 |
| 4.239003727 | 5.739003727 | 11.47800745 | 16.05 | 17.55 | 89.95 | 62.76099627 |
| 4.372978323 | 5.872978323 | 11.74595665 | 16.55 | 18.05 | 89.45 | 62.62702168 |
| 4.506952919 | 6.006952919 | 12.01390584 | 17.05 | 18.55 | 88.95 | 62.49304708 |
| 4.640927515 | 6.140927515 | 12.28185503 | 17.55 | 19.05 | 88.45 | 62.35907248 |
| 4.774902111 | 6.274902111 | 12.54980422 | 18.05 | 19.55 | 87.95 | 62.22509789 |
| 4.908876708 | 6.408876708 | 12.81775342 | 18.55 | 20.05 | 87.45 | 62.09112329 |
| 5.042851304 | 6.542851304 | 13.08570261 | 19.05 | 20.55 | 86.95 | 61.9571487 |
| 5.1768259 | 6.6768259 | 13.3536518 | 19.55 | 21.05 | 86.45 | 61.8231741 |
| 5.310800496 | 6.810800496 | 13.62160099 | 20.05 | 21.55 | 85.95 | 61.6891995 |
| 5.444775093 | 6.944775093 | 13.88955019 | 20.55 | 22.05 | 85.45 | 61.55522491 |
| 5.578749689 | 7.078749689 | 14.15749938 | 21.05 | 22.55 | 84.95 | 61.42125031 |
| 5.712724285 | 7.212724285 | 14.42544857 | 21.55 | 23.05 | 84.45 | 61.28727572 |
| 5.846698881 | 7.346698881 | 14.69339776 | 22.05 | 23.55 | 83.95 | 61.15330112 |
| 5.980673477 | 7.480673477 | 14.96134695 | 22.55 | 24.05 | 83.45 | 61.01932652 |
| 6.114648074 | 7.614648074 | 15.22929615 | 23.05 | 24.55 | 82.95 | 60.88535193 |
| 6.24862267 | 7.74862267 | 15.49724534 | 23.55 | 25.05 | 82.45 | 60.75137733 |
| 6.382597266 | 7.882597266 | 15.76519453 | 24.05 | 25.55 | 81.95 | 60.61740273 |
| 6.516571862 | 8.016571862 | 16.03314372 | 24.55 | 26.05 | 81.45 | 60.48342814 |
| 6.650546458 | 8.150546458 | 16.30109292 | 25.05 | 26.55 | 80.95 | 60.34945354 |
| 6.784521055 | 8.284521055 | 16.56904211 | 25.55 | 27.05 | 80.45 | 60.21547895 |
| 6.918495651 | 8.418495651 | 16.8369913 | 26.05 | 27.55 | 79.95 | 60.08150435 |
| 7.052470247 | 8.552470247 | 17.10494049 | 26.55 | 28.05 | 79.45 | 59.94752975 |
| 7.186444843 | 8.686444843 | 17.37288969 | 27.05 | 28.55 | 78.95 | 59.81355516 |
| 7.32041944 | 8.82041944 | 17.64083888 | 27.55 | 29.05 | 78.45 | 59.67958056 |
| 7.454394036 | 8.954394036 | 17.90878807 | 28.05 | 29.55 | 77.95 | 59.54560596 |
| 7.588368632 | 9.088368632 | 18.17673726 | 28.55 | 30.05 | 77.45 | 59.41163137 |
| 7.722343228 | 9.222343228 | 18.44468646 | 29.05 | 30.55 | 76.95 | 59.27765677 |
| 7.856317824 | 9.356317824 | 18.71263565 | 29.55 | 31.05 | 76.45 | 59.14368218 |
| 7.990292421 | 9.490292421 | 18.98058484 | 30.05 | 31.55 | 75.95 | 59.00970758 |
| 8.124267017 | 9.624267017 | 19.24853403 | 30.55 | 32.05 | 75.45 | 58.87573298 |
| 8.258241613 | 9.758241613 | 19.51648323 | 31.05 | 32.55 | 74.95 | 58.74175839 |
| 8.392216209 | 9.892216209 | 19.78443242 | 31.55 | 33.05 | 74.45 | 58.60778379 |
| 8.526190805 | 10.02619081 | 20.05238161 | 32.05 | 33.55 | 73.95 | 58.47380919 |
| 8.660165402 | 10.1601654 | 20.3203308 | 32.55 | 34.05 | 73.45 | 58.3398346 |
| 8.794139998 | 10.29414 | 20.58828 | 33.05 | 34.55 | 72.95 | 58.20586 |
| 8.928114594 | 10.42811459 | 20.85622919 | 33.55 | 35.05 | 72.45 | 58.07188541 |
| 9.06208919 | 10.56208919 | 21.12417838 | 34.05 | 35.55 | 71.95 | 57.93791081 |
| 9.196063787 | 10.69606379 | 21.39212757 | 34.55 | 36.05 | 71.45 | 57.80393621 |
| 9.330038383 | 10.83003838 | 21.66007677 | 35.05 | 36.55 | 70.95 | 57.66996162 |
| 9.464012979 | 10.96401298 | 21.92802596 | 35.55 | 37.05 | 70.45 | 57.53598702 |
| 9.731962171 | 11.23196217 | 22.46392434 | 36.55 | 38.05 | 69.45 | 57.26803783 |
| 9.999911364 | 11.49991136 | 22.99982273 | 37.55 | 39.05 | 68.45 | 57.00008864 |
| 10.26786056 | 11.76786056 | 23.53572111 | 38.55 | 40.05 | 67.45 | 56.73213944 |
| 10.53580975 | 12.03580975 | 24.0716195 | 39.55 | 41.05 | 66.45 | 56.46419025 |
| 10.80375894 | 12.30375894 | 24.60751788 | 40.55 | 42.05 | 65.45 | 56.19624106 |
| 11.07170813 | 12.57170813 | 25.14341627 | 41.55 | 43.05 | 64.45 | 55.92829187 |
| 11.33965733 | 12.83965733 | 25.67931465 | 42.55 | 44.05 | 63.45 | 55.66034267 |
| 11.60760652 | 13.10760652 | 26.21521304 | 43.55 | 45.05 | 62.45 | 55.39239348 |
| 11.87555571 | 13.37555571 | 26.75111142 | 44.55 | 46.05 | 61.45 | 55.12444429 |
| 12.1435049 | 13.6435049 | 27.28700981 | 45.55 | 47.05 | 60.45 | 54.8564951 |
| 12.4114541 | 13.9114541 | 27.82290819 | 46.55 | 48.05 | 59.45 | 54.5885459 |
| 12.67940329 | 14.17940329 | 28.35880658 | 47.55 | 49.05 | 58.45 | 54.32059671 |
| 12.94735248 | 14.44735248 | 28.89470496 | 48.55 | 50.05 | 57.45 | 54.05264752 |
| 13.21530167 | 14.71530167 | 29.43060335 | 49.55 | 51.05 | 56.45 | 53.78469833 |
| 13.48325087 | 14.98325087 | 29.96650173 | 50.55 | 52.05 | 55.45 | 53.51674913 |

In this case, in deriving each value of Table 1, Table 2 is set as parameter values.

TABLE 2

| Parameters | Value | |
|---|---|---|
| 0.5 times angle of view | 15 | degrees |
| Distance between WG1 (first substrate (311)) and | 0.05 | mm |
| optical member (330) (cover glass) | | |
| Thickness of optical member (330) | 0.5 | mm |
| R2 | 3 | mm |
| Length of projector (200) in emission direction | 1.5 | mm |
| Thickness of barrel (291) | 1 | mm |

| | |
|---|---|
| Refractive index of air | 1 |
| Refractive index of optical member (330) | 1.8 |

Accordingly, in FIG. 15, LI1 denotes a shape corresponding to the user's face, and as in Table 1, as LI2, that is, the distance from the projector to the first substrate is adjusted (tested by adjusting the thickness of the cover glass, which is an optical member), it can be seen that a collision with the user's face occurs when the distance from the projector to the first substrate is greater than 42 mm. In FIG. 15, an x-axis and a y-axis refer to a length (mm) and refer to horizontal and vertical lengths of the human face. Accordingly, a collision between users can also be avoided according to the expressions according to the embodiment.

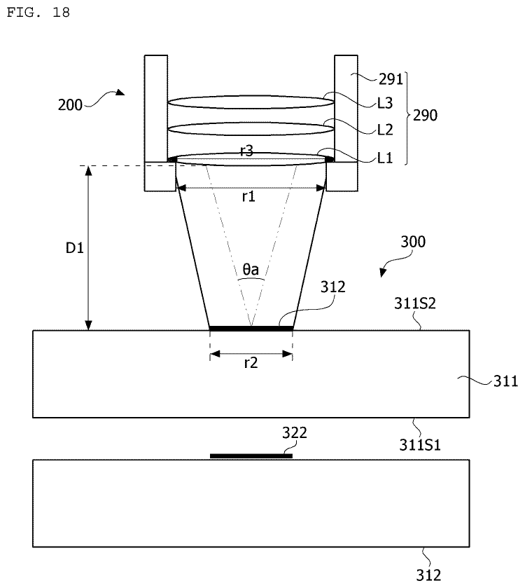

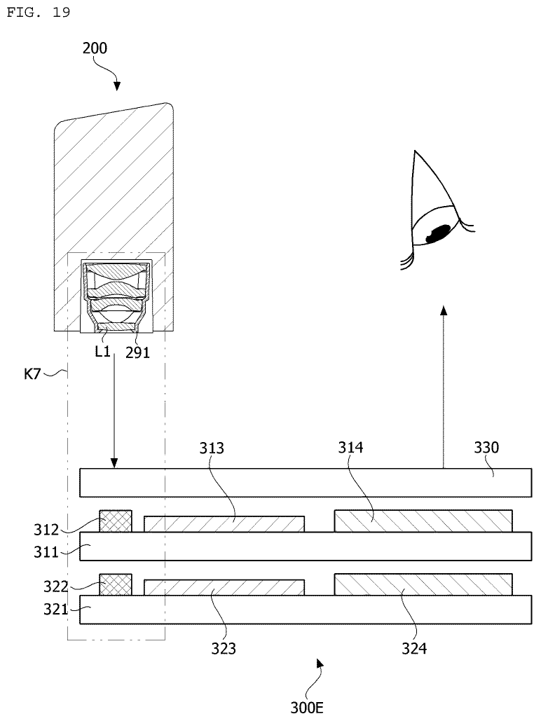

FIG. 17 is a view illustrating a projector and a light guide device according to a fifth embodiment, and FIG. 18 is an enlarged view of portion K6 in FIG. 17.

Referring to FIGS. 17 and 18, a light guide device 300D according to a fifth embodiment may include the first substrate 311 and the first diffraction element portions 312, 313, and 314. Furthermore, the light guide device 300D may include the projector 200. Alternatively, the projector 200 may be separated from the light guide device 300D. All of the above-described contents excluding the following content may be applied to the description thereof.

In the present embodiment, the light guide device 300D may further include a second substrate 321 and second diffraction element units 322, 323, and 324 in addition to the first substrate 311, the first diffraction element region 312, the third diffraction element region 313, and the second diffraction element region 314 as described above.

That is, the light guide device 300D according to the present embodiment may include the first substrate 311, the first diffraction element region 312, the third diffraction element region 313, the second diffraction element region 314, the second substrate 321, the fourth diffraction element region 322, the sixth diffraction element region 323, and the fifth diffraction element region 324 as described above.

The second substrate 321, the fourth diffraction element region 322, the sixth diffraction element region 323, and the fifth diffraction element region 324 may be disposed on a lower surface of the first substrate 311. For example, the second substrate 321 may be positioned under the first substrate 311.

The second substrate 321, the fourth diffraction element region 322, the sixth diffraction element region 323, and the fifth diffraction element region 324 may be disposed to be spaced apart from the projector 200 on the first substrate 311. The second substrate 321, the fourth diffraction element region 322, the sixth diffraction element region 323, and the fifth diffraction element region 324 may overlap the first substrate 311 in the first direction in which light is incident. The fourth diffraction element region 322, the sixth diffraction element region 323, and the fifth diffraction element region 324 may be disposed between the first substrate 311 and the second substrate 321. The optical member 330 may be positioned on the first substrate 311, the first diffraction element region 312, the third diffraction element region 313, and the second diffraction element region 314. The optical member 330 may be disposed adjacent to the projector 200 on the first substrate 311, the first diffraction element region 312, the third diffraction element region 313, and the second diffraction element region 314. The light may pass through the optical member 330 and may be incident on the first diffraction element region 312. The optical member 330 may have an effect of protecting the inside of the light guide device 300D. The refractive index of the optical member 330 may be about 1.5.

The second substrate 321 may serve as a path for transmitting light. The fourth diffraction element region 322, the sixth diffraction element region 323, and the fifth diffraction element region 324 may be disposed on the second substrate 321. The light may be totally reflected from the inside of the second substrate 321 and may travel along the inside of the second substrate 321. The second substrate 321 may include a waveguide. The fourth diffraction element region 322, the sixth diffraction element region 323, and the fifth diffraction element region 324 may be disposed to be spaced apart from each other on the second substrate 321. The second substrate 321 may be disposed in the second direction perpendicular to the first direction in which light is incident. The refractive indices of the first substrate 311 and the second substrate 321 may range from 1.4 to 2.0.

The fourth diffraction element region 322 may serve as a path along which light is incident. The second input diffraction element 1200 may be disposed on the second substrate 321. Light may be incident through the second input diffraction element 1200 and transmitted through the second substrate 321. The fourth diffraction element region 322 may change the path of light by diffracting the light.

The sixth diffraction element region 323 may serve to change the path of the light. The sixth diffraction element region 323 may be disposed on the second substrate 321. The sixth diffraction element region 323 may change the path of the light incident through the fourth diffraction element region 322. The sixth diffraction element region 323 may change the path of the light to guide the light toward the fifth diffraction element region 324. The sixth diffraction element region 323 may change the path of the light by diffracting the light.

The fifth diffraction element region 324 may serve as a path along which light is emitted. The fifth diffraction element region 324 may be disposed on the second substrate 321. The light may be emitted to the outside of the light guide device 300D through the fifth diffraction element region 324. The fifth diffraction element region 324 may receive the light whose path has been changed from a second transmission element 2300 and emit the light externally. The fifth diffraction element region 324 may change the path of the light and emit the light externally. The second emission diffraction element may change the path of the light by diffracting the light.

The fourth diffraction element region 322, the sixth diffraction element region 323, and the fifth diffraction element region 324 may include a plurality of protrusions. The plurality of protrusions may have a constant width, cycle, and height and may be disposed on the fourth diffraction element region 322, the sixth diffraction element region 323, and the fifth diffraction element region 324. The plurality of protrusions may protrude in the first direction on the fourth diffraction element region 322, the sixth diffraction element region 323, and the fifth diffraction element region 324. The plurality of protrusions may be disposed to be spaced apart from each other in a vector direction of the pattern including the protrusions, which is perpendicular to the first direction. Depending on the widths, cycles, and heights of the plurality of protrusions, the path of the light may be changed differently after passing through the fourth diffraction element region 322, the sixth diffraction element region 323, and the fifth diffraction element region 324. The width of the protrusion may be a width of the pattern including the protrusion in the vector direction. The cycle of the protrusion may be an interval of the patterns including a protrusion between one side surface of the protrusion and one side surface of an adjacent protrusion. The height of the protrusion may be a height of a portion of the protrusion, which protrudes in the first direction. Refractive indices of the first diffraction element region 312, the third diffraction element region 313, the second diffraction element region 314, the fourth diffraction element region 322, the sixth diffraction element region 323, and the fifth diffraction element region 324 may range from 1.7 to 2.7. Refractive indices of the first diffraction element region 312, the third diffraction element region 313, the second diffraction element region 314, the fourth diffraction element region 322, the sixth diffraction element region 323, and the fifth diffraction element region 324 may be greater than or equal to the refractive indices of the first substrate 311 and the second substrate 321.

Furthermore, as described above, the first diffraction element region may be positioned on the lower surface (the surface not facing the projector, the first surface) of the first substrate 311. In addition, an optical member may be positioned between the projector 200 and the first substrate 311.

In addition, Expressions 1 to 4 may also be applied in the same manner. In particular, Expression 3 may be applied in the same manner in FIG. 19 described below.

FIG. 19 is a view illustrating a projection device and a light guide device according to a sixth embodiment.

Referring to FIG. 19, a light guide device 300E according to a sixth embodiment may include the first substrate 311 and the first diffraction element units 312, 313, and 314. Furthermore, the light guide device 300E may include the projector 200. Alternatively, the projector 200 may be separated from the light guide device 300E. All of the above-described contents excluding the following content may be applied to the description thereof.

In the present embodiment, the light guide device 300E according to the present embodiment may include the first substrate 311, the first diffraction element region 312, the third diffraction element region 313, the second diffraction element region 314, the second substrate 321, the fourth diffraction element region 322, the sixth diffraction element region 323, the fifth diffraction element region 324, and the optical member 330 as described above.

In this regard, Expression 3 may be applied. As a modified example, the light guide device 300E may have the optical member 330, and the projector 200 may also include the additional optical member (corresponding to the above-described “CG”). In this case, Expression 4 may be applied.

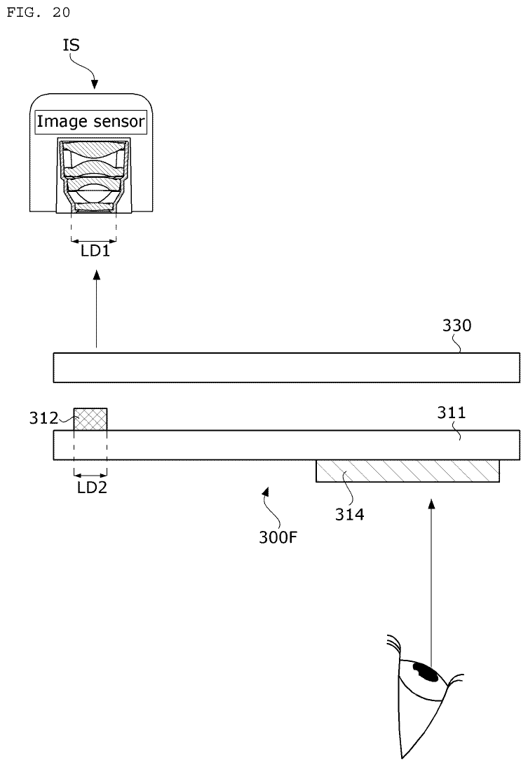

FIG. 20 is a view illustrating a light guide device according to a seventh embodiment.

Referring to FIG. 20, a light guide device 300F according to a seventh embodiment may include the first substrate and the first diffraction element units 313 and 314. All of the above-described contents excluding the following content may be applied to the description thereof.

In the present example, a light receiving unit IS (e.g., an image sensor) rather than a projector may be disposed on the light guide device 300F. Hereinafter, the light receiving unit or the image sensor will be described as the light receiving unit IS.

In addition, in the present example, an optical path between the above-described projector and the user (e.g., the eyes) may be replaced with an optical path between the light receiving unit IS and the user (e.g., the eyes). In addition, the optical path between the light receiving unit IS and the user (e.g., the eyes) may be a path opposite to the optical path between the above-described projector and the user (e.g., the eyes). That is, as the path opposite to the optical path provided from the projector to the user (e.g., the eyes), the optical path between the light receiving unit IS and the user (e.g., the eyes) may be a case in which light (e.g., an image) for the user's eyes is provided from the user (e.g., the eyes) to the second diffraction element region 314, and then provided from the first diffraction element region 312 to the light receiving unit IS via the first substrate.

In addition, the size of the first diffraction element region 312 may be larger than the size LD1 (e.g., a diameter, a width) of the light receiving unit IS. In addition, the size of the first diffraction element region 312 may be smaller than the size LD1 (e.g., a diameter, a width) of the light receiving unit IS depending on a design. Hereinafter, the size of the light receiving unit IS or the projector (or the light source unit) may be the size of an effective diameter or an effective region, such as a diameter, a length, a width, etc.

In addition, as described below, a projector may be further added. Accordingly, light projected through the projector may be transmitted to the user (e.g., eyes) through the first diffraction element region 312 and the second diffraction element region 314, and light reflected from the user (e.g., eyes) may be incident on the light receiving unit IS through the second diffraction element region 314, the first diffraction element region 312 (or the additional diffraction element region 315).

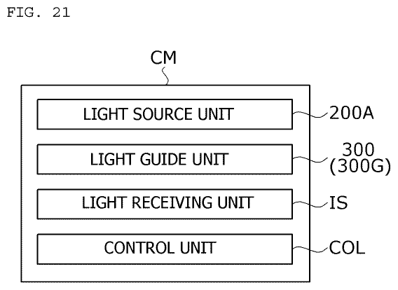

The size LD2 (e.g., a diameter, a width) of the first diffraction element region 312 may be larger or smaller than the size (e.g., a diameter, a width) of the projector. In addition, the size of the first diffraction element region 312 may be larger or smaller than the size LD1 (e.g., a diameter, a width) of the light receiving unit IS. Detailed description thereof will be given with reference to FIGS. 21 to 23.

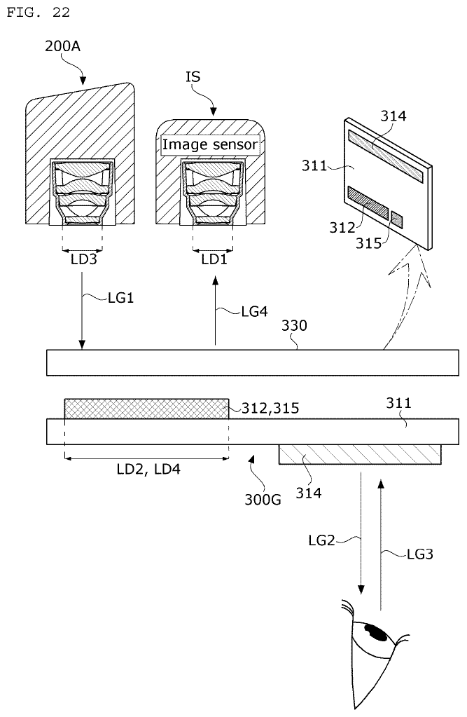

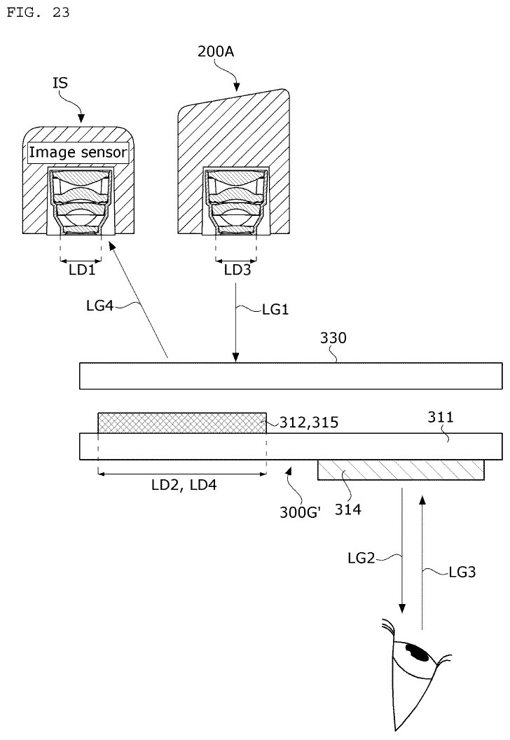

FIG. 21 is a block diagram illustrating an example (a camera module) of the electronic device according to the embodiment, FIG. 22 is a view for describing a configuration and operation of the camera module of FIG. 21, and FIG. 23 is a modified example of FIG. 22.

First, the above-described electronic device may be a camera module or may include the camera module. In addition, the camera module (or the electronic device) may be applied to a system. The vehicle system (or an environment) may vehicle include a vehicle, a passenger (a driver), and an electronic device. In the following description, the electronic device is described as a device separately provided in a vehicle, but the present invention is not limited thereto. For example, the electronic device may be implemented as a part of the vehicle.

The vehicle may include a vehicle body and various devices (e.g., wheels, a driving device for driving the wheels, a start device for turning on the driving device, an engine for generating power and transmitting the generated power to the driving device, a steering device for controlling a direction of the vehicle, an accelerator device for controlling a speed of the vehicle, etc.) for moving the vehicle body. In addition, the vehicle may include various electrical systems. For example, the electrical system may include an engine control device for controlling the engine, a temperature control device for controlling an internal temperature of the vehicle, a light control device for controlling lights according to external conditions, and the like.

In particular, the vehicle may include a communication interface capable of communicating with the electronic device, and an additional processor for analyzing data transmitted through the communication interface and performing a preset function according to the result of the analysis.

The processor may be implemented as, for example, the above-described engine control device or motor control unit. The communication interface may support at least one of various communication methods, such as controller area network (CAN) communication that supports transmission and reception of data in a vehicle, wired communication through a cable connected to the electronic device, etc. As an example, the vehicle may receive an image acquired by the electronic device or the result of analyzing the image and perform a specified function according to the received result.

According to the embodiment, the electronic device may be connected to a camera module CM to acquire an image of a driver may analyze the acquired image, and then perform various set function processing (e.g., deceleration processing, turning on or off an emergency light, horn device control, vehicle vibration control, window open/close control, etc.) according to the result of the analysis. In addition, in addition to such function processing, various function processing may be additionally implemented.

In addition, the driver may be a person who may sit in the driver's seat and control a steering device and may be a subject of image to be captured by the electronic device. In the present invention, an example in which the electronic device acquires the image of the driver who sits in the driver's seat is described as a representative example, but the present invention is not limited thereto. For example, a monitoring system may be applied to acquire images of not only the driver but also a passenger who sits in a passenger seat or other seats and adjust an image acquisition method according to various actions of the passenger.

The camera module CM may be disposed at a position at which the passenger can be easily captured in the vehicle. For example, the camera module CM may be disposed at various positions, such as a specific position of the vehicle, such as a windshield (e.g., a position at which a head-up display is disposed) or the bottom of the windshield, a dashboard, an instrument panel, etc., in order to acquire an image of a subject who sits in the driver's seat. Furthermore, the camera module CM may be disposed at a position at which it is difficult for the passenger to easily recognize the camera module CM.

In addition, the camera module CM connected to the electronic device may be disposed at a predetermined position in the vehicle to receive image information on the passenger other than the driver of the vehicle. For example, one or more camera modules CM may be present, and the camera module CM may be positioned on a rearview mirror (or a room mirror) or the like to detect all passengers other than the driver. Accordingly, the camera module CM may generate images of all passengers.

Referring to FIG. 21, the camera module CM according to the embodiment may include a light source unit 200A, a light guide device 300G, the light receiving unit IS, and a control unit COL.

First, the light source unit 200A may output light by a control signal. Finally, the light output from the light source unit 200A may be radiated to an object. In addition, the light radiated to the object may be reflected and provided to the light receiving unit IS.

The light source unit 200A may include at least one light source. In addition, at least one light source may emit light having a predetermined wavelength band or light having a predetermined center wavelength. In addition, a light source of the light source unit 200A may emit light having a predetermined pattern by a pre-designed algorithm. The light source unit 200A may output light under the control of the control unit COL. The light source unit 200A may include the above-described projector.

Hereinafter, output light or incident light is light output from the light source unit 200A and provided to the object, and input light or reflected light is light that is output from the light source unit 200A, reaches the object, is reflected from the object, and is input to the light receiving unit IS. That is, from the object's perspective, the output light may be incident light, and the input light may be reflected light.

At least one light source of the light source unit 200A may output light having a predetermined wavelength band. For example, the light output from the light source may be infrared rays having the wavelength of 770 nm to 3000 nm. In addition, the light output from the light source may be visible light having the wavelength of 380 nm to 770 nm. Furthermore, the light source of the light source unit 200A may emit light out of the above-described wavelength range. In particular, the light source may radiate light having a specific wavelength band so as not to be harmful to the driver, passengers, etc. in the vehicle as described above or radiate light having specific energy or less so as not to be harmful thereto.

The light source may include a light emitting diode (LED), an organic light emitting diode (OLED), a laser diode (LD), a vertical-cavity surface-emitting laser (VCSEL), a plasma lamp, a fluorescent lamp, an xenon lamp, a halogen lamp, a neon lamp, and the like. The light source may output light having the wavelength of about 800 nm to 1000 nm, for example, about 850 nm or about 940 nm.

The light guide device 300G may be disposed adjacent to the light source unit 200A and the light receiving unit IS. The light guide device 300G may guide the light radiated from the light source unit 200A and transmit the light to the object. In addition, the light guide device 300G may re-guide the light reflected from the object and provide the light to the light receiving unit IS. In this way, the light guide device 300G may be configured to control the light and move the light to a desired path. That is, the light guide device 300G may perform both transmitting the light to the object (e.g., a user, an object, etc.) and receiving the reflected light. Accordingly, the light guide device 300G may be configured to help the light from the camera module CM to accurately reach the sensor or guide the light along a specific path so that optical information is accurately transmitted. The light guide device 300G may include the above-described light guide device or have a similar structure.

The light guide device 300G may be made of a material such as glass, a polymer, silicon, etc. The light guide device 300G may include various other materials capable of light guiding.

In addition, the light guide device 300G may transmit light in a desired direction using diffraction. Accordingly, the light guide device 300G may include an optical element for determining the path of light on a substrate that is a waveguide. The optical element may include various elements that operate based on diffraction.

In an embodiment, the light guide device 300G may include a diffraction element that is a holographic optical element (HOE). The light guide device 300G may include an input diffraction element, an input/output diffraction element, and an output diffraction element as described below. For example, the input diffraction element, the input/output diffraction element, and the output diffraction element may be formed as the HOE.

In addition, the HOE may diffract light (or light) using an interference pattern generated through laser interference to control light having a specific wavelength or diffract the light in a desired direction. In such a diffraction process, Bragg's Law may be applied, and a diffraction angle may be determined according to the wavelength of light and the structure of the HOE.

The HOE may be formed of an interference pattern formed on a transparent substrate. As described above, the transparent substrate may be a waveguide and may be formed of various materials such as glass, plastic, a polymer, etc. The interference pattern of the HOE may be precisely designed inside or on a surface of the substrate to guide light in a specific direction. In addition, the HOE may be classified as a transmission type in which light passes and diffracts and a reflection type in which light is reflected and diffracts. Accordingly, a position of the HOE may be changed on the substrate. The light may be precisely controlled by the HOE to provide a high-resolution image. In addition, the HOE may support high-speed data transmission through wavelength separation and combination in optical communication. In addition, the HOE may provide a miniaturized camera module because it is lighter and thinner than conventional lenses or mirrors. Detailed description of the input diffraction element, the input/output diffraction element, and the output diffraction element that are diffraction elements of the light guide device 300G will be described below.

The light receiving unit IS may receive light transmitted through the light guide device 300G. The light receiving unit IS may include an image sensor. The image sensor may receive light reflected from an object. Accordingly, the image sensor may detect light and convert the light into an electrical signal. For example, the image sensor may convert an electrical signal to generate a digital image. The image sensor may include a charge-coupled device (CCD), a complementary metal-oxide-semiconductor (CMOS), an InGaAs sensor, a HgCdTe sensor, a microbolometer, etc. The light receiving unit IS may include an image sensor for receiving light having various wavelength bands other than the above-described contents or examples.

Furthermore, the light receiving unit IS may further include a lens unit or an optical unit on the image sensor. Accordingly, the size of the light receiving unit IS may correspond to the size of the effective diameter or effective region of the lens unit or the optical unit. In particular, the size of the light receiving unit IS may be a diameter length of the effective diameter of the lens that is closest to the first substrate or faces the first substrate.

In addition, the light receiving unit IS may also be positioned adjacent to the light guide device 300G like the light source unit 200A. Alternatively, an additional lens (not illustrated) may be further disposed between the light receiving unit IS and the light guide device 300G. This may be applied between the light source unit 200A and the light guide device 300G in the same manner.

The control unit COL may control the operations of the light source unit 200A and the light receiving unit IS. In addition, the control unit COL may generate depth information based on the image generated by the light receiving unit IS or transmit and receive image information with other electronic devices such as a vehicle, etc. The control unit COL may control the operations of components in the camera module and communicate with a processor in a device such as an external electronic device such as a vehicle, etc.

The control unit COL may include a processor, a microcontroller (MCU), a field programmable gate array (FPGA), an application specific integrated circuit (ASIC), etc., and may also be implemented in the form of an application processor (AP) of various electronic devices. Referring to FIG. 22, the light guide device 300G may include the first substrate 311, an input diffraction element 312, an input/output diffraction element 314, and an output diffraction element 315. The input diffraction element 312 may correspond to the above-described first diffraction element region. The input/output diffraction element 314 may correspond to the above-described second diffraction element region. In addition, the output diffraction element 315 may be the first diffraction element region or the additional diffraction element region. In this way, the diffraction element region may correspond to a “diffraction element.” For example, the input diffraction element 312 and the output diffraction element 315 may be formed integrally or separated. Accordingly, the first diffraction element region and the additional diffraction element region may be formed integrally or separated.

The input diffraction element 312, the input/output diffraction element 314, and the output diffraction element 315 may be disposed on the first substrate 311, which is a waveguide. The input diffraction element 312, the input/output diffraction element 314, and the output diffraction element 315 may correspond to one of a transmissive type and a reflective type and may be positioned on one of one surface (e.g., an upper surface) or the other surface (e.g., a lower surface) of the first substrate 311. For example, the input diffraction element 312 and the output diffraction element 315 may be positioned on a surface opposite to a surface on which the input/output diffraction element 314 is disposed of the first substrate 311. That is, the input diffraction element 312 and the output diffraction element 315 may be positioned on a surface different from or opposite to the surface of the input/output diffraction element 314.

In addition, the input diffraction element 312, the input/output diffraction element 314, and the output diffraction element 315 are diffraction elements as described above and may be disposed to be spaced apart from each other.

The input diffraction element 312 may be configured so that the incident angle of the optical axis of the light radiated from the light source unit 200A varies depending on the wavelength based on the grating vector of the input diffraction element 312.

In addition, the input diffraction element 312 may be formed of a plurality of diffraction elements or may include a plurality of regions. For example, the input diffraction element 312 may be composed of an integrated diffraction element. In an embodiment, the input diffraction element 312 may be formed of a plurality of sub-elements.

In addition, according to the embodiment, light LG1 emitted from the light source unit 200A may be input to the input diffraction element 312, and the input diffraction element 312 may diffract the light radiated from the light source unit 200A and guide the light into the first substrate 311.

The input diffraction element 312 may diffract the light LG1 provided from the light source unit 200A and guides the diffracted light LG1 into the first substrate 311, and the light guided into the first substrate 311 may be provided to the input/output diffraction element 314.

The input/output diffraction element 314 may diffract the light guided from the input diffraction element 122 to the first substrate 311 to an object (LG2) and diffract light LG3 reflected from the object and guide the diffracted light LG3 into the first substrate 311.

Specifically, the input/output diffraction element 314 may diffract the light guided from the input diffraction element 312 to the first substrate 311 and guide the diffracted light to the object. That is, the input/output diffraction element 314 may diffract light to the object (LG2).

The object may be various objects (e.g., users, objects, etc.) outside the camera module or the light guide device 300G. That is, the object may be various objects that may be detected or recognized through the camera module and may include people, vehicles, animals, buildings, and the like. For example, a passenger in a vehicle or a building or object outside the vehicle may correspond to the object.

In addition, the light LG2 emitted from the input/output diffraction element 314 may be reflected from the object and provided to the input/output diffraction element 314 (LG3). In this case, the light LG3 provided to the input/output diffraction element 314 may be diffracted by the input/output diffraction element 314 to change the optical path.

Accordingly, the input/output diffraction element 314 may diffract the light reflected from the object and guide the diffracted light to the first substrate 311. In this case, the light diffracted by the input/output diffraction element 314 and guided to the first substrate 311 may be guided or provided to the output diffraction element 315.

The output diffraction element 315 may diffract the light reflected from the object and guided to the first substrate 311 by the input/output diffraction element 314 and guide or provide the diffracted light to the light receiving unit IS. In this case, the light LG4 diffracted by the output diffraction element 315 and guided to the light receiving unit IS may be incident on the light receiving unit IS and converted into image information.

The camera module according to the present embodiment may be formed of an illumination system and an imaging system. The illumination system may serve to illuminate a target in an optical system. The illumination system may uniformly disperse or concentrate light to help a target or subject appear clearly. In addition, the imaging system may serve to form an image of the target in the optical system. The imaging system may collect light to make a focus and form an image of its result on an image sensor, a film, or the eyes. The illumination system and the imaging system work together in the optical system to play an important role in forming accurate and clear images.

The illumination system may be composed of components on a path in which the light emitted from the light source 200A passes through the input diffraction element 312, the first substrate 311, and the input/output diffraction element 314 and is provided to an object. The imaging system may be composed of components on a path in which the light reflected from the object passes through the input/output diffraction element 314, the first substrate 311, and the output diffraction element 315 and is provided to the light receiving unit IS. For example, the illumination system may include the light source, the input diffraction element 312, the first substrate 311, and the input/output diffraction element 314. The imaging system may include the input/output diffraction element 314, the first substrate 311, the output diffraction element 315, and the light receiving unit IS. The camera module may include components (e.g., the substrate, the input/output diffraction element) belonging to both the illumination system and the imaging system.

In addition, the size LD2 of the first diffraction element region 312 may be larger than the size LD1 (e.g., a diameter, a width) of the light receiving unit IS. In addition, the size LD2 of the first diffraction element region 312 may be smaller than the size LD1 (e.g., a diameter, a width) of the light receiving unit IS depending on a design. In addition, the size LD2 (e.g., a diameter, a width) of the first diffraction element region 312 may be larger than the size LD3 (e.g., a diameter, a width) of the light source unit 200A that is the projector. Depending on the design, as various examples, the size LD1 (e.g., a diameter, a width, or a diagonal length in the case of a quadrangular shape) of the first diffraction element region 312 may be smaller than the size LD3 (e.g., a diameter, a width) of the light source unit 200A that is the projector.

Furthermore, the additional diffraction element region 315 that is the output diffraction element may be adjacent to or formed integrally with the first diffraction element region 312. A size LD4 (e.g., a diameter, a width) of the additional diffraction element region 315 may be larger than the size LD1 (e.g., a diameter, a width) of the light receiving unit IS. In addition, the size LD4 (e.g., a diameter, a width) of the additional diffraction element region 315 may be smaller than the size LD1 (e.g., a diameter, a width) of the light receiving unit IS. The size LD4 (e.g., a diameter, a width) of the additional diffraction element region 315 may be larger than the size LD3 (e.g., a diameter, a width) of the light source unit 200A that is the projector. In addition, depending on the design, the size LD4 (e.g., a diameter, a width) of the additional diffraction element region 315 may be smaller than the size LD3 (e.g., a diameter, a width) of the light source unit 200A that is the projector.

In addition, as in the above-described various examples, the electronic device may be a camera module or may include the camera module. Accordingly, at least one of the projector and the light receiving unit IS (or the image sensor) may be disposed on the light guide device 300E. For example, the electronic device may include the light guide device 300E and the projector. Alternatively, the electronic device may include the light guide device 300E and the light receiving unit IS. Alternatively, the electronic device may include the light guide device 300E, the projector, and the light receiving unit IS.

Referring to FIG. 23, a light guide device 300G′ according to the modified example may have positions between the light guide device 300G, the light receiving unit IS, and the light source unit 200A different from those of FIG. 22. For example, the light source unit 200A may be positioned between the light receiving unit IS and the input/output diffraction element 314. In addition, the light receiving unit IS or the light source unit 200A may be tilted to have a predetermined angle with respect to the light guide device 300G′, or an optical path may be partially changed. In addition, the light receiving unit IS and the light source unit 200A may be disposed at various positions so that the diffraction element 315, which is an output additional diffraction element corresponding to the light receiving unit IS, and the input diffraction element 312 corresponding to the light source unit 200A may have various sizes as described above.

In using the light guide device used for augmented reality (AR) or the like, and the electronic device including the same, the diameter of the lens and the distance between the projector and the first diffraction element are adjusted, thereby increasing diffraction efficiency and enabling miniaturization and compactness.

In addition, it is possible to implement the light guide device and the electronic device, which have the reduced volume by adjusting the position of each element.

Various and beneficial advantages and effects of the present invention are not limited to the above-described contents and will be more readily understood in a process of describing specific embodiments of the present invention.

The features, structures, effects, and the like described above in the embodiments are included in at least one embodiment, and are not necessarily limited to only one embodiment. Furthermore, the features, structures, effects, and the like exemplified in each embodiment may be combined or modified and implemented in other embodiments by those skilled in the art to which the embodiments pertain. Therefore, the contents related to such combinations and modifications should be construed as being included in the scope of the embodiments.

Although the embodiments have been mainly described above, these are only illustrative and do not limit the present invention, and those skilled in the art to which the present invention pertains can know that various modifications and applications that are not exemplified above are possible without departing from the essential characteristics of the embodiments. For example, each component specifically shown in the embodiments may be implemented by modification. In addition, differences related to these modifications and applications should be construed as being included in the scope of the embodiments defined in the appended claims.

What is claimed is:

1. A light guide device comprising:
a projector including a lens disposed to emit light and a barrel coupled to the lens;
a first substrate that guides the light emitted from the projector;
a first diffraction element region that is disposed on the first substrate and receives the light; and
a second diffraction element region disposed on the first substrate and spaced apart from the first diffraction element region,
wherein the lens includes a first lens disposed closest to the first substrate,
the first diffraction element region overlaps the first lens of the projector in an optical axis direction of the first lens, and
a diameter of the first diffraction element region of the first substrate is smaller than a diameter of the first lens of the projector.

2. The light guide device of claim 1, wherein the diameter of the first diffraction element region of the first substrate is smaller than a diameter of the barrel of the projector.

3. The light guide device of claim 1, wherein the first lens of the projector is disposed to face the first diffraction element region of the first substrate.

4. The light guide device of claim 3, wherein the projector has an angle of view, and
the diameter of the first diffraction element region of the first substrate and the diameter of the first lens of the projector satisfy Expression 1 below:
$$1.9 * [ IC / 2 + y 1 ] <= diameter of first lens <= 2.1 * [ IC / 2 + y 1 ] \qquad [ Equation 1 ]$$
$$y 1 = distance between first diffraction element region and L 1 S 1 * tan ( H \_ Fov )$$
(here, IC denotes the diameter of the first diffraction element region, L1S1 denotes a surface of the first lens, which is adjacent to the first substrate, H_Fov denotes half or 0.5 times an angle of view of the projector, and distance between first diffraction element region and L1S1 denotes the shortest distance from the center of the first lens to the center of the diameter of the first diffraction element region).

5. The light guide device of claim 1, wherein the first diffraction element region of the first substrate is disposed on a surface of two surfaces of the first substrate, which does not face the first lens of the projector.

6. The light guide device of claim 5, wherein the projector has an angle of view, and
the diameter of the first diffraction element region of the first substrate and the diameter of the first lens of the projector satisfy Expression 2 below:
$$1.9 * [ IC / 2 + y 2 ] <= diameter of first lens <= 2.1 * [ IC / 2 + y 2 ] \qquad [ Equation 2 ]$$
$$y 2 = distance between WG 1 S 2 and L 1 S 1 * tan ( H \_ Fov ) +$$
$$thickness of first substrate ( WG 1 ) * tan ( a sin ( n 0 * sin ( H \_ Fov ) / n\_WG 1 ) )$$
(here, IC denotes the diameter of the first diffraction element region, L1S1 denotes a surface of the first lens, which is adjacent to the first substrate, WG1S2 denotes a surface of the first substrate, which is adjacent to the first lens of the projector, H_Fov denotes ½ time an angle of view θb of the projector, no denotes a diffractive index of air, and n_WG1 denotes a diffractive index of the first substrate).

7. The light guide device of claim 1, comprising an optical member disposed on the first diffraction element region of the first substrate.

8. The light guide device of claim 7, wherein a diffractive index of the optical member is greater than a diffractive index of air and is equal to or smaller than a diffractive index of the first substrate.

9. The light guide device of claim 7, wherein a thickness of the optical member is equal to or smaller than a thickness of the first substrate.

10. The light guide device of claim 7, wherein a size of the optical member is larger than a diameter of the first lens of the projector.

11. The light guide device of claim 7, wherein a distance between the optical member and the first substrate is shorter than a distance between the optical member and the first lens of the projector.

12. The light guide device of claim 7, wherein the projector has an angle of view, and
the diameter of the first diffraction element region of the first substrate and the diameter of the first lens of the projector satisfy Expression 3 below:
$$1.9 * [ IC / 2 + y 3 ] <= diameter of first lens <= 2.1 * [ IC / 2 + y 3 ] \qquad [ Equation 3 ]$$
$$y 3 = ( distance between WG 1 S 2 and L 1 S 1 - thickness of optical member * tan ( H \_ Fov ) + thickness of optical member * tan ( a sin ( n 0 * sin ( H \_ Fov ) / n 1 ) )$$
(here, IC denotes the diameter of the first diffraction element region, L1S1 denotes a surface (a first lens surface) of the first lens, which is adjacent to the first substrate, WG1S2 denotes a surface (a second surface) of the first substrate, which is adjacent to the first lens of the projector, H_Fov denotes ½ of an angle of view θb of the projector, no denotes a refractive index of air, n_WG1 denotes a refractive index of the first substrate, and n1 denotes a refractive index of the optical member).

13. The light guide device of claim 7, wherein a length from the first substrate to the optical member is smaller than the thickness of the optical member.

14. A light guide device comprising:
a projector including a lens disposed to emit light and a barrel coupled to the lens;
a first substrate that guides the light emitted from the projector and disposed adjacent to the projector and a second substrate disposed under the first substrate;
a first diffraction element region that is disposed on the first substrate and receives the light; and
a second diffraction element region disposed on the first substrate and spaced apart from the first diffraction element region,
wherein the lens includes a first lens disposed closest to the first substrate,
the first diffraction element region overlaps the first lens of the projector in an optical axis direction of the first lens, and
a diameter of the first diffraction element region of the first substrate is smaller than a diameter of the first lens of the projector.

15. The light guide device of claim 14, wherein the projector has an angle of view, and
the diameter of the first diffraction element region of the first substrate and the diameter of the first lens of the projector satisfy Expression 1 below:
$$1.9 * [ IC / 2 + y 1 ] <= diameter of first lens <= 2.1 * [ IC / 2 + y 1 ] \qquad [ Equation 1 ]$$
$$y 1 = distance between first diffraction element region and L 1 S 1 * tan ( H \_ Fov )$$
(here, IC denotes the diameter of the first diffraction element region, L1S1 denotes a surface of the first lens, which is adjacent to the first substrate, H_Fov denotes half or 0.5 times an angle of view of the projector, and distance between first diffraction element region and L1S1 denotes the shortest distance from the center of the first lens to the center of the diameter of the first diffraction element region).

16. The light guide device of claim 14, wherein the projector has an angle of view,
the first diffraction element region of the first substrate is disposed on a surface of two surfaces of the first substrate, which does not face the first lens of the projector, and
the diameter of the first diffraction element region of the first substrate and the diameter of the first lens of the projector satisfy Expression 2 below:
$$1.9 * [ IC / 2 + y 2 ] <= diameter of first lens <= 2.1 * [ IC / 2 + y 2 ] \qquad [ Equation 2 ]$$
$$y 2 = distance between WG 1 S 2 and L 1 S 1 * tan ( H \_ Fov ) +$$
$$thickness of first substrate ( WG 1 ) * tan ( a sin ( n 0 * sin ( H \_ Fov ) / n\_WG 1 ) )$$
(here, IC denotes the diameter of the first diffraction element region, L1S1 denotes a surface of the first lens, which is adjacent to the first substrate, WG1S2 denotes a surface of the first substrate, which is adjacent to the first lens of the projector, H_Fov denotes ½ time an angle of view θb of the projector, no denotes a diffractive index of air, and n_WG1 denotes a diffractive index of the first substrate).

17. The light guide device of claim 14, comprising an optical member disposed on the first diffraction element region of the first substrate,
wherein the projector has an angle of view,
the diameter of the first diffraction element region of the first substrate and the diameter of the first lens of the projector satisfy Expression 3 below:
$$1.9 * [ IC / 2 + y 3 ] <= diameter of first lens <= 2.1 * [ IC / 2 + y 3 ] \qquad [ Equation 3 ]$$
$$y 3 = ( distance between WG 1 S 2 and L 1 S 1 - thickness of optical member * tan ( H \_ Fov ) + thickness of optical member * tan ( a sin ( n 0 * sin ( H \_ Fov ) / n 1 ) )$$
(here, IC denotes the diameter of the first diffraction element region, L1S1 denotes a surface (a first lens surface) of the first lens, which is adjacent to the first substrate, WG1S2 denotes a surface (a second surface) of the first substrate, which is adjacent to the first lens of the projector, H_Fov denotes ½ of an angle of view θb of the projector, no denotes a refractive index of air, n_WG1 denotes a refractive index of the first substrate, and n1 denotes a refractive index of the optical member).
